(19) United States
(12) Patent Application Publication
(10) Pub. No.: US 2026/0162685 A1
(43) Pub. Date: Jun. 11, 2026

(54) ELECTRONIC DEVICE AND VIDEO EDITING METHOD USING THE ELECTRONIC DEVICE

(71) Applicant: SAMSUNG ELECTRONICS CO., LTD., Suwon-si (KR)

(72) Inventors: Soomin KANG, Suwon-si (KR); Kyoosung SO, Suwon-si (KR); Yurie KIM, Suwon-si (KR); Woongil CHOI, Suwon-si (KR); Iljun AHN, Suwon-si (KR)

(73) Assignee: SAMSUNG ELECTRONICS CO., LTD., Suwon-si (KR)

(21) Appl. No.: 19/396,859

(22) Filed: Nov. 21, 2025

Related U.S. Application Data
(63) Continuation of application No. PCT/KR2025/018948, filed on Nov. 17, 2025.

(30) Foreign Application Priority Data
Dec. 6, 2024 (KR) 10-2024-0180809

(51) Int. Cl. G11B 27/031; G06T 5/70; G06T 5/73

(52) U.S. Cl. CPC G11B 27/031; G06T 5/70; G06T 5/73; G06T 2207/10016

(57) ABSTRACT

A method of editing a video by an electronic device includes receiving a first user input indicating a selected plurality of videos to be edited into a single output video, determining a reference video from among the selected plurality of videos, obtaining a reference image quality-related parameter of the reference video by analyzing the reference video, applying the reference image quality-related parameter to each video of the selected plurality of videos resulting in a plurality of adjusted videos whose image quality has been adjusted, and combining the plurality of adjusted videos into the single output video.

### CROSS-REFERENCE TO RELATED APPLICATIONS

This application is a continuation application of International Application No. PCT/KR2025/018948, filed on Nov. 17, 2025, which claims priority to Korean Patent Application No. 10-2024-0180809, filed on Dec. 6, 2024, in the Korean Intellectual Property Office, the disclosures of which are incorporated by reference herein in their entireties.

### BACKGROUND

### 1. Field

The present disclosure relates generally to image processing, and more particularly, to a method of editing a plurality of videos into one video and an electronic device for the method.

### 2. Description of Related Art

The term image quality may refer to the quality of an image medium. For example, in an image that may include various objects, the image quality may be considered based on the degree to which each object may be clearly distinguished and to the degree to which the subject of the image may be clearly identified. Consequently, images may be determined to exhibit different levels of image quality that may result from a photographing environment (e.g., indoor/outdoor, camera type, and exposure value) under which the images may have been captured and that may be different for each image.

Currently, various image editing tools may be available that may allow users to check the image quality of an image and/or to manually modify the image quality. However, users may find it difficult to manually edit the image quality of images one by one by using an image editing tool.

### SUMMARY

One or more example embodiments of the present disclosure provide method of editing a plurality of videos into one video and an electronic device for the method.

According to an aspect of the present disclosure, a method of editing a video by an electronic device includes receiving a first user input indicating a selected plurality of videos to be edited into an output video, determining a reference video from among the selected plurality of videos, obtaining a reference image quality-related parameter of the reference video by analyzing the reference video, applying the reference image quality-related parameter to each video of the selected plurality of videos resulting in a plurality of adjusted videos whose image quality has been adjusted, and combining the plurality of adjusted videos into the output video.

According to an aspect of the present disclosure, an electronic device includes memory storing at least one instruction, and at least one processor including processing circuitry. The at least one instruction, when executed by the at least one processor, cause the electronic device to receive a user input indicating a selected plurality of videos to be edited into an output video, determine a reference video from among the selected plurality of videos, obtain an image quality-related parameter of the reference video by analyzing the reference video, apply the image quality-related parameter to each video of the selected plurality of videos resulting in a plurality of adjusted videos whose image quality has been adjusted, and combine the plurality of adjusted videos into the output video.

According to an aspect of the present disclosure, a non-transitory computer-readable storage medium stores a computer-executable program for editing a video that, when executed by at least one processor of an electronic device, cause the electronic device to receive a user input indicating a selected plurality of videos to be edited into an output video, determine a reference video from among the selected plurality of videos, obtain an image quality-related parameter of the reference video by analyzing the reference video, apply the image quality-related parameter to each video of the selected plurality of videos resulting in a plurality of adjusted videos whose image quality has been adjusted, and combine the plurality of adjusted videos into the output video.

Additional aspects may be set forth in part in the description which follows and, in part, may be apparent from the description, and/or may be learned by practice of the presented embodiments.

### DESCRIPTION OF DRAWINGS

The above and other aspects, features, and advantages of certain embodiments of the present disclosure may be more apparent from the following description taken in conjunction with the accompanying drawings, in which:

FIG. 1 is a diagram of an electronic device for editing a video, according to an embodiment of the present disclosure;

FIG. 2 is a flowchart of a method by which an electronic device edits a video, according to an embodiment of the present disclosure;

FIG. 3 is a diagram of an analyzer and a processing module of an electronic device, according to an embodiment of the present disclosure;

FIG. 4 is a diagram of an operation in which an electronic device analyzes a plurality of videos, according to an embodiment of the present disclosure;

FIG. 5 is a diagram of an operation in which an electronic device obtains contrast information of a reference video, according to an embodiment of the present disclosure;

FIG. 6 is a diagram of an operation in which an electronic device obtains color tone information of a reference video, according to an embodiment of the present disclosure;

FIG. 7 is a diagram of an operation in which an electronic device obtains a sharpness enhancement strength of each video, according to an embodiment of the present disclosure;

FIG. 8 is a diagram of an operation in which an electronic device adjusts the image quality of a plurality of videos, according to an embodiment of the present disclosure;

FIG. 9 is a diagram of an operation in which an electronic device adjusts a contrast of each video, according to an embodiment of the present disclosure;

FIG. 10 is a diagram of an operation in which an electronic device interpolates mapping functions around a corresponding pixel, according to an embodiment of the present disclosure;

FIG. 11 is a diagram of an operation in which an electronic device transfers a color tone of each video, according to an embodiment of the present disclosure;

FIG. 12 is a diagram of an operation in which an electronic device enhances a sharpness of each video, according to an embodiment of the present disclosure;

FIG. 13 is a flowchart of a method by which an electronic device additionally adjusts the image quality of a video according to a user input, according to an embodiment of the present disclosure;

FIG. 14 is a diagram of an operation in which an electronic device additionally adjusts the image quality of a video according to a user input, according to an embodiment of the present disclosure; and

FIG. 15 is a block diagram of a function of an electronic device, according to an embodiment of the present disclosure.

### DETAILED DESCRIPTION

The terms used herein are described, and various embodiments of the present disclosure are described.

The terms used herein may be general terms currently widely used in the art in consideration of functions in various embodiments of the present disclosure, but the terms may vary according to the intention of one of ordinary skill in the art, precedents, or new technology in the art. Also, some terms may be arbitrarily selected by the applicant, and in this case, the meaning of the selected terms is described in the description of an embodiment of the present disclosure. Accordingly, the specific terms used herein may be defined based on the unique meanings thereof and the whole context of the present disclosure.

Throughout the present disclosure, the expression “at least one of a, b, or c” may indicate only a, only b, only c, both a and b, both a and c, both b and c, all of a, b, and c, or variations thereof.

In the present disclosure, when a portion “includes” an element, another element may be further included, rather than excluding the existence of the other element, unless otherwise described. Also, the term such as “ . . . unit” or “ . . . module” used herein may refer to a unit that may perform at least one function or operation, and the unit may be implemented as hardware or software or as a combination of hardware and software.

It is to be appreciated that the blocks in each flowchart and combinations of the flowcharts may be performed by one or more computer programs which include instructions. The one or more computer programs may be stored in a single memory or the one or more computer programs may be divided with different portions stored in different multiple memories.

It is to be understood that the singular forms (e.g., “a,” “an,” and “the”) include plural referents unless the context clearly dictates otherwise. Thus, for example, reference to “a component surface” may include reference to one or more of such surfaces.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

Any of the functions or operations described herein may be processed by one processor and/or a combination of processors. One processor and/or a combination of processors may be and/or may include circuitry performing processing, and may include circuitry such as, but not limited to, an application processor (AP), a communication processor (CP), a graphics processing unit (GPU), a neural processing unit (NPU) a microprocessor unit (MPU), a system on chip (SoC), an integrated circuit (IC), or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings. However, an embodiment of the present disclosure may be implemented in many different forms and may not be limited to the embodiments described herein. Also, in the drawings, parts irrelevant to the description may be omitted in order to clearly describe an embodiment of the present disclosure, and like reference numerals may denote like elements throughout the present disclosure.

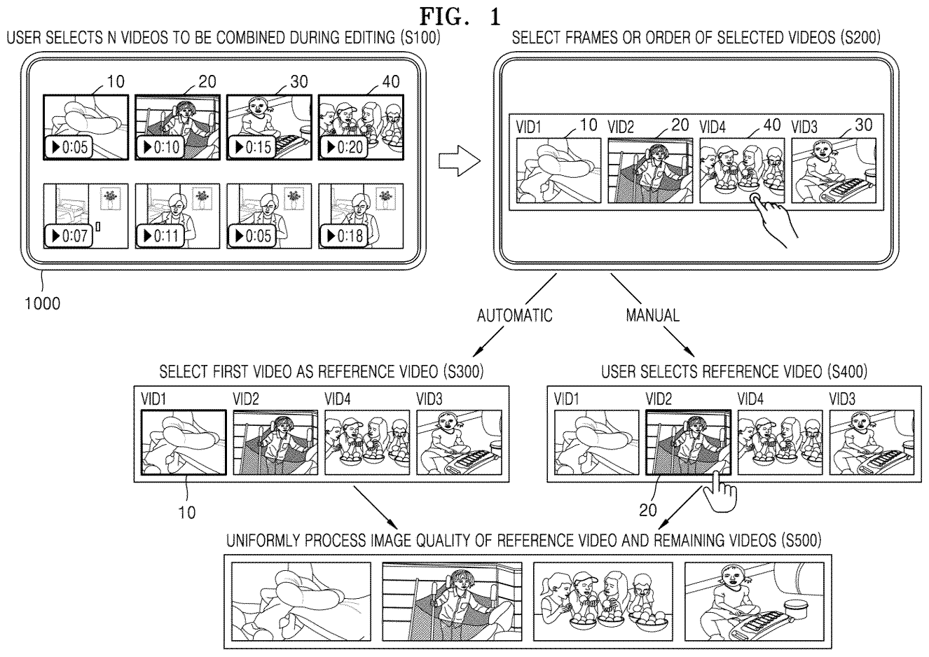

FIG. 1 is a diagram of an electronic device 1000 for editing a video, according to an embodiment of the present disclosure.

The electronic device 1000, according to an embodiment of the present disclosure, may be implemented in various forms. Examples of the electronic device 1000 may include, but may not be limited to, a digital camera, a smartphone, a laptop computer, a tablet personal computer (PC), an e-book terminal, a digital broadcasting terminal, a personal digital assistant (PDA), and a portable multimedia player (PMP). The electronic device 1000 may also be and/or may include a wearable device that may be worn on a user. The wearable device may include at least one of, but may not be limited to, an accessory-type device (e.g., a watch, a ring, a wrist band, an ankle band, a necklace, glasses, or a contact lens), a head-mounted device (HMD), a fabric or clothing integrated device (e.g., electronic clothing), a body-attachable device (e.g., a skin pad), and a bio-implantable device (e.g., an implantable circuit). For convenience of explanation, the following may be described assuming that the electronic device 1000 is a smartphone. However, embodiments of the present disclosure may not be limited thereto.

According to an embodiment of the present disclosure, the electronic device 1000 may provide various functions of editing a video. For example, the electronic device 1000 may provide a function of editing a plurality of videos into one video.

Referring to FIG. 1, when the user executes a photo management application, the electronic device 1000 may provide a photo or video list through an execution window of the photo management application. For example, as shown in FIG. 1, the user may select N videos to be edited into one video (operation S100) from the photo or video list provided by the photo management application, where N is a positive integer is greater than one (1). For example, the user may select a first video 10, a second video 20, a third video 30, and a fourth video 40 (e.g., N=4).

The electronic device 1000 may receive an input that indicates the selected frames and/or an order of the selected first to fourth videos 10 to 40 (operation S200). For example, the user may select some of the frames and/or videos included in the execution window of the photo management application. Alternatively or additionally, the user may adjust a combination order of the selected videos. For example, the user may change the order of the third video 30 and the fourth video 40. That is, the user may adjust the combination order so that the videos are played in the order of the first video 10, the second video 20, the fourth video 40, and the third video 30. However, the embodiments of the present application are not limited in this regard, and the number of selected videos and/or the combination order of the selected videos may vary without departing from the scope of the present disclosure.

The electronic device 1000 may select a reference video from among the selected first to fourth videos 10 to 40. The reference video may be a video that functions as a standard (reference) for setting image-quality parameters of the selected first to fourth videos 10 to 40 such as, but not limited to, contrast, color tone, sharpness, or the like. For example, when the selected first to fourth videos 10 to 40 are captured in different conditions (e.g., indoor/outdoor, camera type, and exposure value), there may be variations in contrast, color tone, and sharpness among the captured videos. Accordingly, when the videos captured in different conditions are simply combined, the user may feel a sense of incongruity when viewing the combined video. Accordingly, aspects of the present disclosure provide an electronic device 1000 that may select one of the selected first to fourth videos 10 to 40 as a reference video to uniformly process the image quality of the selected first to fourth videos 10 to 40.

According to an embodiment of the present disclosure, the electronic device 1000 may select a first order video as the reference video (operation S300) from among the selected first to fourth videos 10 to 40. That is, the electronic device 1000 may determine, as the reference video, the first order video from among the selected first to fourth videos 10 to 40, based on a combination order of the selected first to fourth videos 10 to 40. For example, when the combination order is the first video 10, the second video 20, the fourth video 40, and the third video 30, the electronic device 1000 may automatically select the first video 10, which is the first order video, as the reference video.

According to an embodiment of the present disclosure, the electronic device 1000 may select a video selected by the user as the reference video (operation S400). For example, the user may select the second video 20 from among the selected first to fourth videos 10 to 40 as the reference video, and the electronic device 1000 may determine the second video 20 as the reference video based on the selection of the user.

According to an embodiment of the present disclosure, the electronic device 1000 may uniformly process the image quality of the reference video and the remaining videos based on the reference video from among the selected first to fourth videos 10 to 40 selected by the user (operation S500). For example, when the first video 10 is selected as the reference video, the electronic device 1000 may improve the image quality of the second video 20, the third video 30, and the fourth video 40 to be uniform with a contrast, a color tone, or the like of the first video 10. Alternatively or additionally, the electronic device 1000 may enhance a sharpness of the first video 10 to a maximum sharpness, and may enhance a sharpness of the second video 20, the third video 30, and the fourth video 40, based on the enhanced sharpness. Although an example of adjusting a contrast, a color tone, and a sharpness of each video is described with reference to FIG. 1, the present disclosure is not limited thereto. For example, the electronic device 1000 may adjust additional and/or different image quality values, such as, but not limited to, brightness, exposure, saturation, color temperature, clarity, or the like.

The electronic device 1000 may combine and edit the first video 10, the second video 20, the third video 30, and the fourth video 40, which are processed to have uniform image quality, in the order of the first video 10, the second video 20, the fourth video 40, and the third video 30, and may edit the processed videos into one video. Because the selected first to fourth videos 10 to 40 selected by the user are processed to have uniform image quality, the user may not feel a sense of incongruity between the selected first to fourth videos 10 to 40 while playing the combined video. That is, a natural transition between the selected first to fourth videos 10 to 40 may be induced.

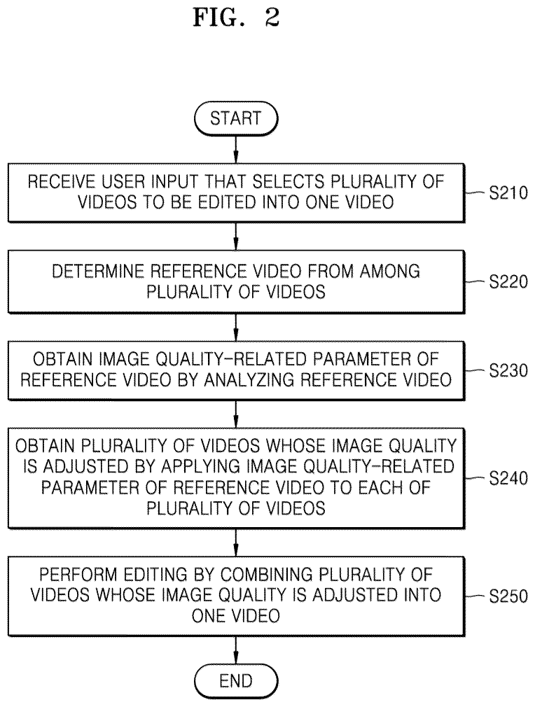

Hereinafter, a method by which the electronic device 1000 processes a plurality of videos to have uniform image quality is described with reference to FIG. 2.

FIG. 2 is a flowchart of a method by which the electronic device 1000 edits a video, according to an embodiment of the present disclosure.

Referring to FIG. 2, the method by which the electronic device 1000 edits a video may include operations S210 to S250. In an embodiment of the present disclosure, operations S210 to S250 may be performed by at least one processor included in the electronic device 1000. The method by which the electronic device 1000 edits a video is not limited to that illustrated in FIG. 2, and in one or more embodiments of the present disclosure, operations not shown in FIG. 2 may be further included and/or some operations may be omitted.

In operation S210, the electronic device 1000, according to an embodiment of the present disclosure, may receive a user input that selects a plurality of videos to be edited into one video.

According to an embodiment of the present disclosure, the electronic device 1000 may provide a video list to a user. The electronic device 1000 may provide the video list through a certain application (e.g., a photo management application). The video list may include, but is not limited to, identification information of videos stored in memory of the electronic device 1000 (e.g., thumbnail image, total playback time, a file name, or) and/or identification information of videos stored in an external device (e.g., a cloud server). The electronic device 1000 may receive a user input that selects a plurality of videos from the video list. That is, the user may select videos stored in the memory of the electronic device 1000 and/or may select videos stored in the external device.

According to an embodiment of the present disclosure, the electronic device 1000 may receive a user input that selects a plurality of videos and at least one still image (e.g., a photograph). Alternatively or additionally, the electronic device 1000 may receive a user input that selects a plurality of still images (e.g., photographs) for generating one video, and/or selects a plurality of still images (photographs) and music. For convenience of explanation, the following description is based on an example scenario in which the user selects a plurality of videos. However, embodiments of the present disclosure are not limited in this regard.

According to an embodiment of the present disclosure, the electronic device 1000 may receive an input that changes a combination order (selection order) of the plurality of videos. For example, after the user selects videos in the order of a first video, a second video, and a third video, the user may change the order (positions) of the first video and the third video. For example, the user may instruct that the videos may be played in the order of the first video, the third video, and the second video.

According to an embodiment of the present disclosure, the electronic device 1000 may receive an input that adds an effect to some of the plurality of videos. For example, the electronic device 1000 may receive an input that adds a bokeh effect and/or adds text or an emoticon to some of the plurality of videos. However, embodiments of the present disclosure are not limited in this regard and various other effects and/or modifications may be applied to the plurality of videos.

In operation S220, the electronic device 1000, according to an embodiment of the present disclosure, may determine a reference video from among the plurality of videos.

According to an embodiment of the present disclosure, the electronic device 1000 may determine one of the plurality of videos as the reference video. The reference video may be a video that functions as a standard for image quality. The electronic device 1000 may determine the reference video in various ways.

According to an embodiment of the present disclosure, the electronic device 1000 may automatically select the reference video according to a combination order (selection order or arrangement order) of the plurality of videos. For example, the electronic device 1000 may determine a first order video from among the plurality of videos as the reference video. Alternatively or additionally, the electronic device 1000 may determine a last order video from among the plurality of videos as the reference video, and/or may determine a middle order video as the reference video.

According to an embodiment of the present disclosure, the electronic device 1000 may automatically select a video having a longest playback time from among the plurality of videos as the reference video, and/or may automatically select a video having a highest sharpness as the reference video.

According to an embodiment of the present disclosure, the electronic device 1000 may determine a video selected by the user from among the plurality of videos as the reference video. For example, when the user selects the second video 20 with a favorite color tone from among the first to third videos 10 to 30, the electronic device 1000 may determine the second video 20 as the reference video.

According to an embodiment of the present disclosure, the user may select and/or change a criterion for determining the reference video. For example, the user may designate that a first order video is be automatically determined as the reference video. Alternatively or additionally, the user may designate that the reference video is manually selected.

In operation S230, the electronic device 1000, according to an embodiment of the present disclosure, may obtain an image quality-related parameter of the reference video by analyzing the reference video.

According to an embodiment of the present disclosure, when the reference video is a red, green, and blue (RGB) video, the electronic device 1000 may convert the reference video into a YUV video. As used herein, YUV may refer to a color representation method in which each color is composed of luminance (Y), blue chrominance (U), and red chrominance (V) information. However, embodiments of the present disclosure are not limited in this regard. That is, the color representation method is not limited to YUV, and may also include, but not be limited to, YCbCr, LAB, or HSV. That is, when the reference video is an RGB video, the electronic device 1000 may convert the reference video into at least one of a YCbCr video, a LAB video, or an HSV video. As used herein, YCbCr may refer to a color representation method in which each color is composed of luma (or brightness) (Y), blue-difference chroma (Cb), and red-difference chroma (Cr) information, LAB may refer to a color representation method in which each color is composed of lightness (L), green-to-red (A), and blue-to-yellow (B) information, and HSV may refer to a color representation method in which each color is composed of hue (H), saturation(S), and brightness value (V) information. However, for convenience of explanation, the present disclosure is described assuming that an RGB video is converted into a YUV video.

The electronic device 1000 may obtain the image quality-related parameter of the reference video by analyzing the reference video converted into a YUV format. The image quality-related parameter may include at least one of, but not be limited to, a contrast score, color information, a sharpness enhancement strength, or the like. Alternatively or additionally, the image quality-related parameter may include brightness, exposure, saturation, color temperature, clarity, or the like.

According to an embodiment of the present disclosure, the electronic device 1000 may select sample frames from among all frames included in the reference video and may analyze the selected sample frames, which may increase a processing speed of the electronic device 1000. However, the present disclosure is not limited thereto. The electronic device 1000 may obtain the image quality-related parameter of the reference video by analyzing all frames included in the reference video. However, the following description is described assuming that the electronic device 1000 samples and analyzes the reference video.

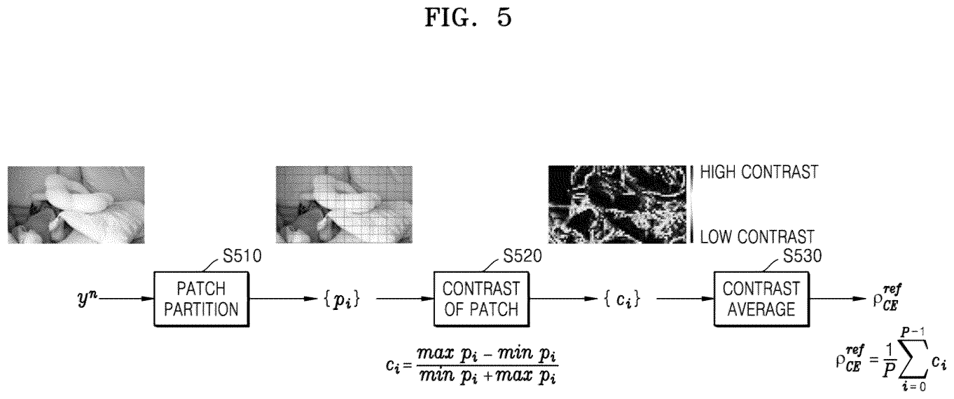

According to an embodiment of the present disclosure, the electronic device 1000 may determine a contrast score of the reference video by using an intensity value of a Y channel of sample frames included in the reference video. For example, the electronic device 1000 may divide each sample frame into a plurality of patches, calculate a contrast for each patch, and then calculate an average of the contrasts for the patches as a contrast score of each sample frame. The electronic device 1000 may determine an average of the contrast scores of the sample frames as a contrast score of the reference video. The contrast of each patch may be a value obtained by dividing a difference between a maximum intensity value and a minimum intensity value by a sum of the maximum intensity value and the minimum intensity value. An operation in which the electronic device 1000 determines the contrast score of the reference video is described below with reference to FIG. 5.

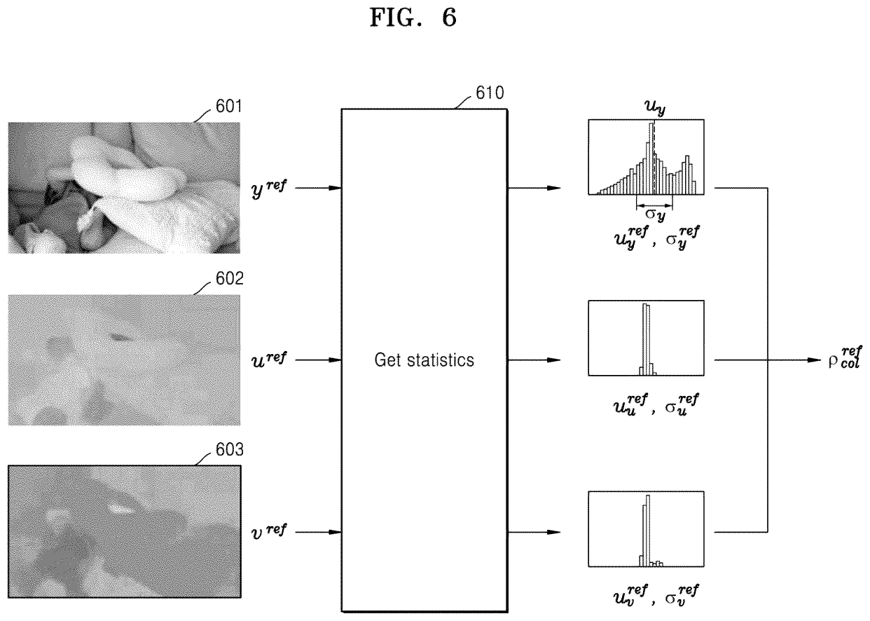

According to an embodiment of the present disclosure, the electronic device 1000 may obtain color tone information of the reference video by using an average and a standard deviation of each of a Y channel, a U channel, and a V channel of the sample frames included in the reference video. For example, the electronic device 1000 may obtain an average of the averages and standard deviations of the Y channel, the U channel, and the V channel of the sample frames as the color tone information of the reference video. An operation in which the electronic device 1000 obtains the color tone information of the reference video is described below with reference to FIG. 6.

According to an embodiment of the present disclosure, the electronic device 1000 may obtain a sharpness corresponding to each of the plurality of videos. For example, the electronic device 1000 may generate a low-frequency image by applying a Gaussian blur to a Y channel of a sample frame included in each video. The electronic device 1000 may detect an edge area in the Y channel of the sample frame included in each video by using an absolute difference between the low-frequency image and the Y channel of the sample frame included in each video. The electronic device 1000 may extract a sharpness enhancement target mask by removing noise from the edge area. The electronic device 1000 may obtain a sharpness of each video by averaging an edge score of the edge area (e.g., the sharpness enhancement target mask) from which the noise is removed.

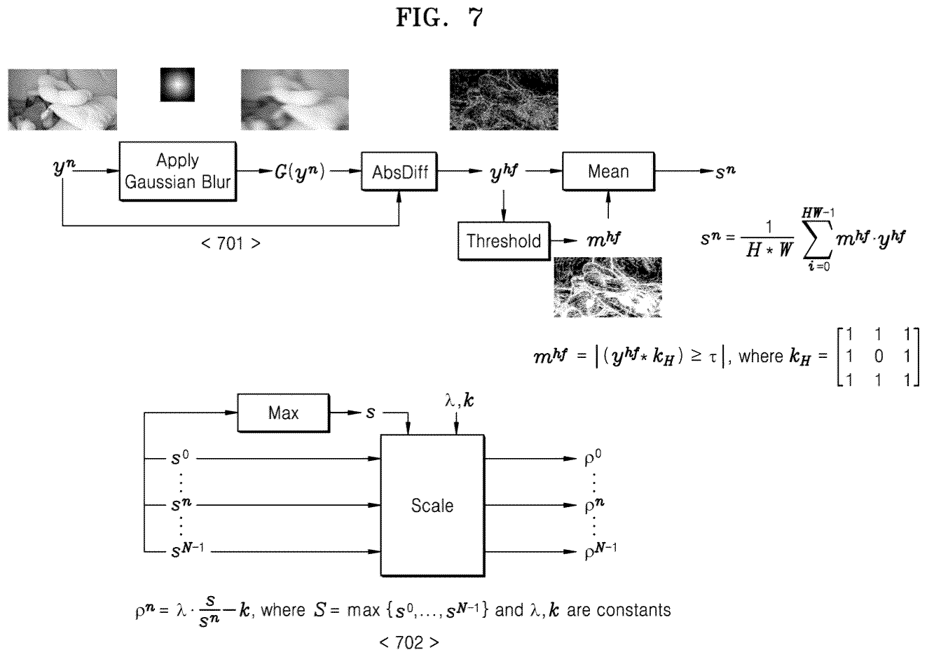

The electronic device 1000 may determine a maximum sharpness from among the sharpness values corresponding to the plurality of videos. The electronic device 1000 may determine a sharpness enhancement strength corresponding to each of the plurality of videos by comparing the maximum sharpness with the sharpness corresponding to each of the plurality of videos. As a sharpness of each video may be lower than the maximum sharpness, a sharpness enhancement strength of the video may increase. An operation in which the electronic device 1000 determines the sharpness enhancement strength corresponding to each of the plurality of videos is described below with reference to FIG. 7.

In operation S240, the electronic device 1000, according to an embodiment of the present disclosure, may obtain a plurality of videos whose image quality is adjusted, by applying the image quality-related parameter of the reference video to each of the plurality of videos.

According to an embodiment of the present disclosure, the electronic device 1000 may convert the plurality of videos of an RGB format into a YUV format, and may obtain the plurality of videos whose image quality is adjusted by applying the image quality-related parameter of the reference video to the plurality of videos converted into the YUV format. For example, the electronic device 1000 may apply the contrast score of the reference video and/or may transfer the color tone of the reference video to the remaining videos other than the reference video from among the plurality of videos. Alternatively or additionally, the electronic device 1000 may apply the sharpness enhancement strength of the reference video to the reference video, and may apply the sharpness enhancement strength of each video to the remaining videos. When the sharpness of the reference video is the maximum sharpness, the electronic device 1000 may apply the sharpness enhancement strength of each video only to the remaining videos. An operation in which the electronic device 1000 applies the image quality-related parameter of the reference video to each of the plurality of videos is described below.

According to an embodiment of the present disclosure, the electronic device 1000 may apply the contrast score of the reference video to the plurality of videos. For example, the electronic device 1000 may determine a contrast score of a current video from among the plurality of videos. The current video may refer to a video to be currently processed. The current video may be an n^{th} video (where n is a positive integer greater than zero (0)) other than the reference video from among the plurality of videos.

The electronic device may compare the contrast score of the current video with the contrast score of the reference video, and may adjust a contrast of the current video so that the contrast score of the current video is substantially similar to and/or the same as the contrast score of the reference video. For example, when the contrast score of the current video is higher than the contrast score of the reference video, the electronic device 1000 may reduce the contrast of the current video by blending each frame included in the current video with a gray image. Alternatively or additionally, when the contrast score of the current video is lower than the contrast score of the reference video, the electronic device 1000 may enhance the contrast of the current video.

For example, the electronic device 1000 may enhance the contrast of the current video by determining an intensity value of each pixel included in each frame of the current video by using mapping functions corresponding to neighboring patches of the pixel. The mapping function may be a cumulative distribution function calculated by clipping bins of a histogram counted more than a reference value (clip value), distributing the bins to other bins, and accumulating the distributed histogram. For example, the electronic device 1000 may divide each frame of the current video into a plurality of patches, and may obtain a histogram corresponding to each patch. The electronic device 1000 may determine a clip value of each histogram by using a mean intensity value of each patch, a variance of intensity values of each patch, and an intensity value of a center pixel. The electronic device 1000 may obtain a modified histogram by distributing bins of the histogram counted more than the clip value to other bins, and may generate a cumulative distribution function by accumulating the modified histogram as a mapping function. When bits of the histogram counted more than a reference value (clip value) are clipped and distributed to other bins, bins having the same intensity value may be changed to bins having different intensity values, thereby increasing an intensity difference and enhancing a contrast.

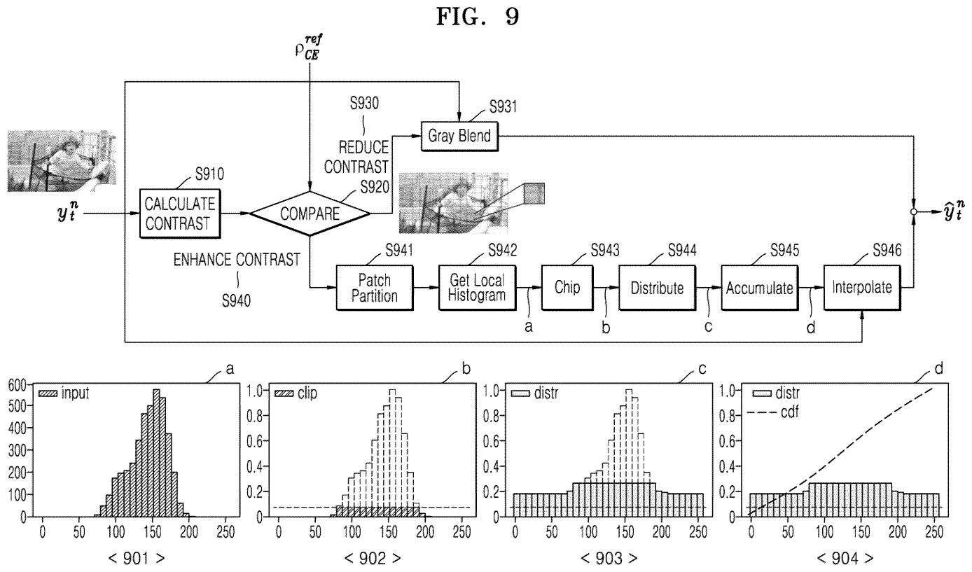

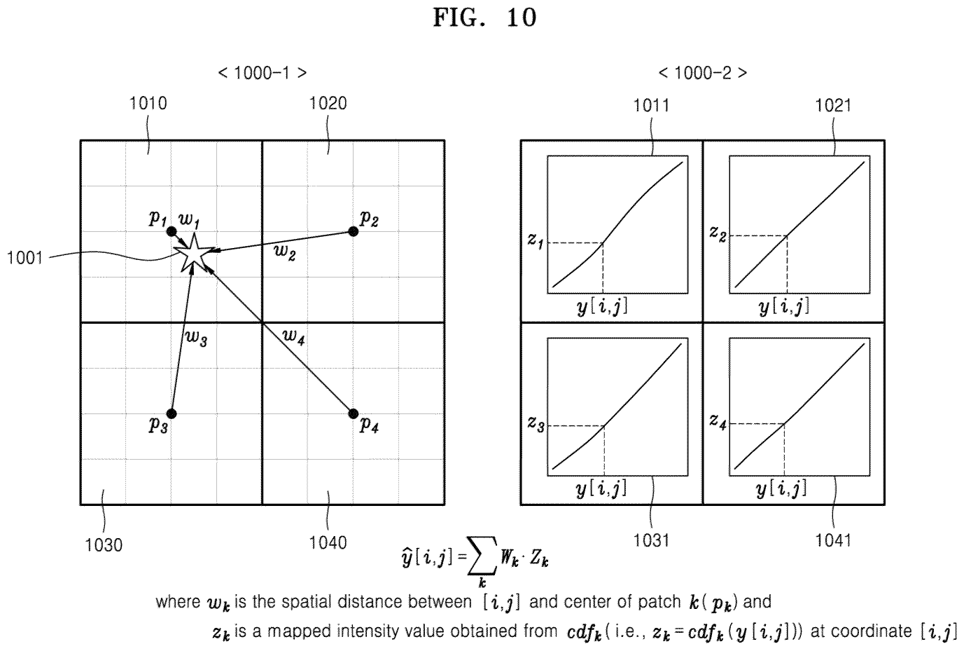

The electronic device 1000 may determine the intensity value of the pixel by interpolating the mapping functions by considering a spatial distance between the pixel and centers of the neighboring patches. When the intensity value of the pixel is determined by using only a mapping function of a patch including the pixel, a boundary between patches may be unnatural. Accordingly, the electronic device 1000 may interpolate the mapping functions, by considering the spatial distance between the pixel and the centers of the neighboring patches. An operation in which the electronic device 1000 enhances a contrast of each video by obtaining a mapping function corresponding to each patch is described below with reference to FIGS. 9 and 10.

According to an embodiment of the present disclosure, the electronic device 1000 may transfer the color tone information of the reference video to the plurality of videos. For example, the electronic device 1000 may adjust color tones of the remaining videos, based on the color tone information of the reference video from among the plurality of videos.

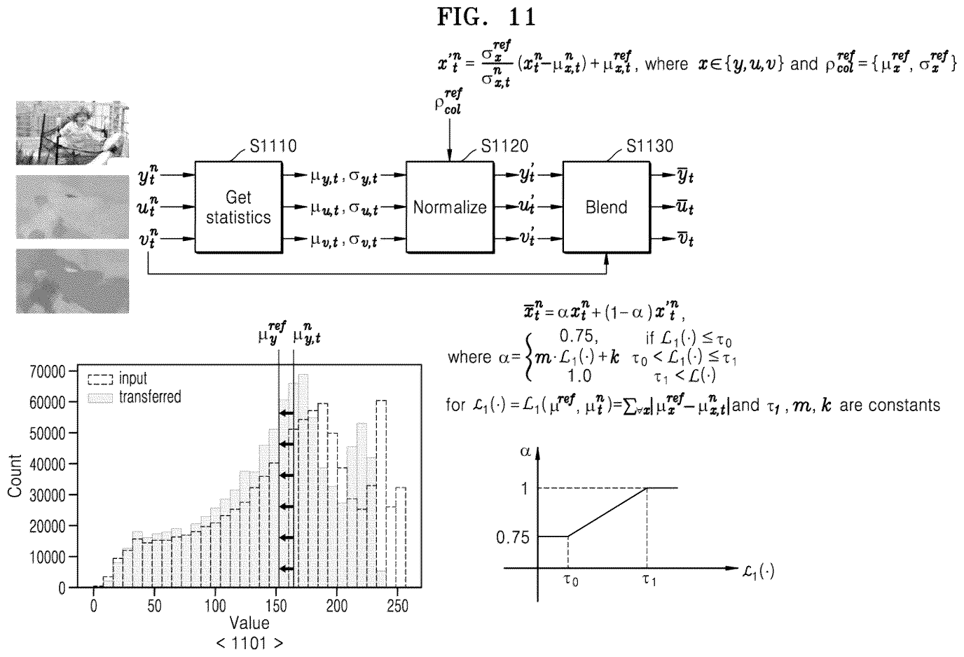

The electronic device 1000 may obtain a channel-wise average and a channel-wise standard deviation of the current video from among the plurality of videos. The channel may include a Y channel, a U channel, and a V channel. The electronic device 1000 may normalize data of each channel of the current video so that the channel-wise average of the current video becomes close to a channel-wise average of the reference video. For example, the electronic device 1000 may normalize data of each channel of the current video by using the channel-wise average and the channel-wise standard deviation of the current video and the channel-wise average and a channel-wise standard deviation of the reference video. The electronic device 1000 may apply blending so that a difference between an input image of the current video and a normalized image is appropriately reflected. For example, the electronic device 1000 may blend data of each channel of the current video with normalized data of each channel of the current video, based on a difference between the channel-wise average of the current video and the channel-wise average of the reference video. When a color tone difference between the current video and the reference video is too large and a color tone of the reference video is transferred to the current video, a color tone of the current video may become unnatural, and thus, the electronic device 1000 may blend data of each channel with normalized data. An operation in which the electronic device 1000 transfers the color tone information of the reference video to each video is described below with reference to FIG. 11.

According to an embodiment of the present disclosure, the electronic device 1000 may obtain a plurality of videos having the same sharpness as the reference video, by using a sharpness enhancement strength corresponding to each of the plurality of videos. For example, the electronic device 1000 may apply a sharpness enhancement strength of the reference video to the reference video, and may apply sharpness enhancement strengths corresponding to the remaining videos to the remaining videos. Because a sharpness enhancement strength of each video may be determined based on a comparison between a sharpness of each video with a maximum sharpness of the plurality of videos, each video may be adjusted to have the maximum sharpness. When the reference video is a video having the maximum sharpness, a sharpness of the reference video may be maintained at its original sharpness level.

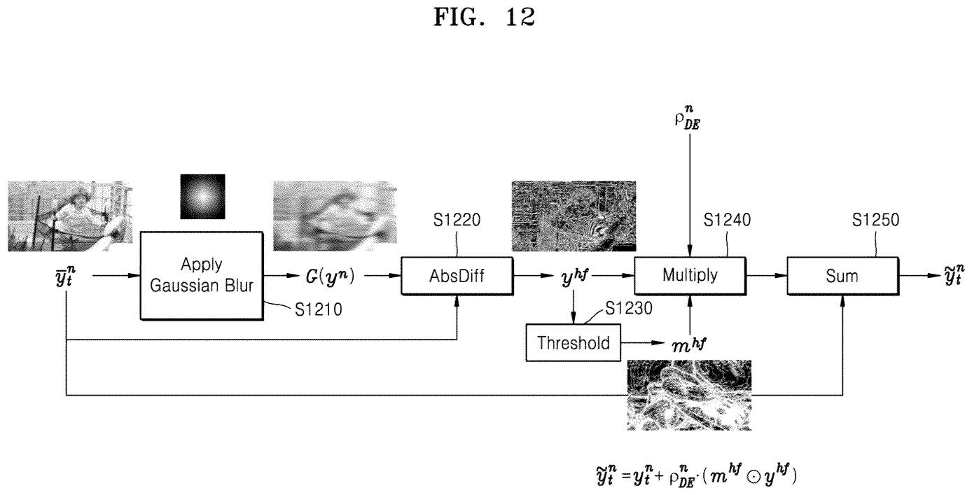

According to an embodiment of the present disclosure, the electronic device 1000 may detect an edge area of each frame included in the current video by applying a Gaussian blur to a Y channel of each frame included in the current video from among the plurality of videos. For example, the electronic device 1000 may extract a low-frequency image by applying a Gaussian blur to the Y channel of each frame. The electronic device 1000 may extract an edge area in the Y channel of each frame by calculating an absolute difference between the low-frequency image and the Y channel image of each frame. The electronic device 1000 may extract a sharpness enhancement target mask to remove noise from the edge area. The electronic device 1000 may apply a sharpness enhancement strength corresponding to the current video to the edge area from which the noise is removed. In such an example, because an edge of each frame becomes clear, a sharpness of each video may be enhanced. An operation in which the electronic device 1000 enhances the sharpness of each video is described below with reference to FIG. 12.

According to an embodiment of the present disclosure, the electronic device 1000 may adjust the image quality of each video in the order of a contrast, a color tone, and a sharpness. However, embodiments of the present disclosure are not limited thereto. For example, the electronic device 1000 may adjust the image quality of each video in the order of a contrast, a sharpness, and a color tone, may adjust the image quality of each video in the order of a color tone, a contrast, and a sharpness, may adjust the image quality of each video in the order of a color tone, a sharpness, and a contrast, may adjust the image quality of each video in the order of a sharpness, a contrast, and a color tone, or may adjust the image quality of each video in the order of a sharpness, a color tone, and a contrast.

According to an embodiment of the present disclosure, the electronic device 1000 may adjust only some of a contrast, a color tone, and a sharpness, or may adjust all of them. For example, the electronic device 1000 may adjust a contrast and a color tone of the plurality of videos, may adjust a contrast and a sharpness of the plurality of videos, may adjust a color tone and a sharpness of the plurality of videos, or may adjust a contrast, a color tone, and a sharpness of the plurality of videos. According to an embodiment of the present disclosure, the electronic device 1000 may adjust a contrast, a color tone, and/or a sharpness of only a portion of the images, or may adjust all of the images. For example, the electronic device 1000 may adjust a contrast and a color tone of a first portion of the plurality of videos, may adjust a contrast and a sharpness of a second portion of the plurality of videos, may adjust a color tone and a sharpness of a third portion of the plurality of videos, and/or may adjust a contrast, a color tone, and a sharpness of a fourth portion of the plurality of videos.

According to an embodiment of the present disclosure, when image quality adjustment for the plurality of videos is completed, the electronic device 1000 may convert the plurality of videos whose image quality is adjusted back into an RGB format.

In operation S250, the electronic device 1000, according to an embodiment of the present disclosure, may perform editing by combining the plurality of videos whose image quality is adjusted into one video.

According to an embodiment of the present disclosure, the electronic device 1000 may edit the plurality of videos into one video according to an order in which the user selects the plurality of videos. For example, when the user selects the videos in the order of the first video 10, the second video 20, the fourth video 40, and the third video 30, the electronic device 1000 may combine the videos in the order of the first video 10, the second video 20, the fourth video 40, and the third video 30. Also, when the user adjusts the order of the plurality of videos, the electronic device 1000 may combine the videos into one video according to the adjusted order.

According to an embodiment of the present disclosure, the electronic device 1000 may store the video edited into one video in memory and/or may output (play) the video through an output interface (e.g., a display and/or a speaker). According to an embodiment of the present disclosure, because the electronic device 1000 uniformly adjusts at least one of a contrast, a color tone, or a sharpness among the plurality of videos based on the image quality-related parameter of the reference video, a sense of congruity (harmony and/or agreement) may be maximized and a sense of incongruity may be minimized when editing the plurality of videos into one video.

Although an example where the electronic device 1000 obtains the plurality of videos whose image quality is adjusted, by applying the image quality-related parameter of the reference video to each of the plurality of videos is described with reference to FIG. 2, the present disclosure is not limited thereto. For example, an external device (e.g., server), instead of the electronic device 1000, may obtain the image quality-related parameter of the reference video by analyzing the reference video, and may obtain the plurality of videos whose image quality is adjusted by applying the image quality-related parameter of the reference video to each of the plurality of videos.

According to an embodiment of the present disclosure, an operation of obtaining the plurality of videos whose image quality is adjusted by applying the image quality-related parameter of the reference video to each of the plurality of videos may be performed through an artificial intelligence (AI) model. For example, when the electronic device 1000 inputs the plurality of videos selected by the user to the AI model, the AI model may output a result obtained by combining the plurality of videos whose image quality is adjusted to the electronic device 1000. In such an example, the AI model may be pre-trained to estimate an image quality-related parameter of each video and apply the image quality-related parameter of the reference video to each video.

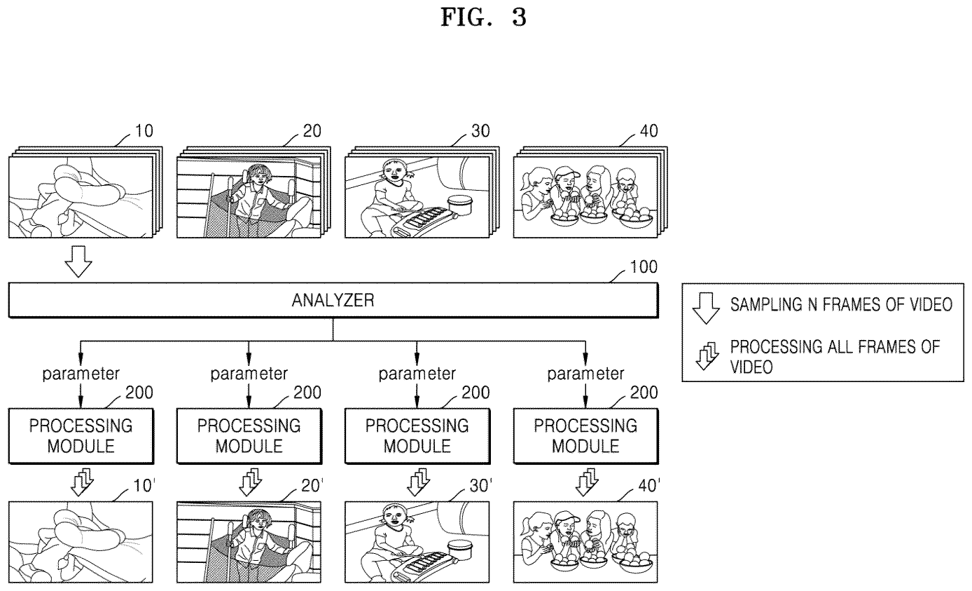

Hereinafter, an operation in which the electronic device 1000 analyzes the image quality-related parameter of the reference video and adjusts the image quality of the plurality of videos is described with reference to FIGS. 3 to 12.

FIG. 3 is a diagram of an analyzer and a processing module of the electronic device 1000, according to an embodiment of the present disclosure.

Referring to FIG. 3, the electronic device 1000 may include a video analyzer 100 and a processing module 200. In an embodiment of the present disclosure, the video analyzer 100 and/or the processing module 200 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the video analyzer 100 and/or the processing module 200. As another example, a processor (e.g., of the electronic device 1000) in combination with a memory may be used to execute one or more instructions to perform the functionality of the video analyzer 100 and/or the processing module 200.

According to an embodiment of the present disclosure, when a user selects a plurality of first to fourth videos 10 to 40 to be edited into one video, the electronic device 1000 may input the plurality of first to fourth videos 10 to 40 to the video analyzer 100. The video analyzer 100 of the electronic device 1000 may analyze an image quality-related feature of each video. For example, the video analyzer 100 of the electronic device 1000 may obtain a contrast score or color tone information of each video by analyzing each video. Alternatively or additionally, the video analyzer 100 of the electronic device 1000 may calculate a sharpness of each video, and may determine a sharpness enhancement strength of each video based on a maximum sharpness from among the sharpness values of the videos.

According to an embodiment of the present disclosure, the video analyzer 100 of the electronic device 1000 may sample N frames of each video and may perform analysis on the sampled N frames, where N is a positive integer greater than one (1). For example, the video analyzer 100 of the electronic device 1000 may extract parameters required for contrast, color tone, and/or sharpness processing of each video, by analyzing the N frames. For example, the video analyzer 100 of the electronic device 1000 may obtain a contrast score, color tone information, and a sharpness enhancement strength of a reference video.

According to an embodiment of the present disclosure, a processing module 200 of the electronic device 1000 may perform processing for uniformly adjusting the image quality of each video. The processing module 200 may include, but may not be limited to, a contrast adjustment module, a color tone transfer module, and a sharpness enhancement module.

According to an embodiment of the present disclosure, the processing module 200 of the electronic device 1000 may reflect the contrast score and the color tone information of the reference video (e.g., the first video 10) to the remaining videos (e.g., the second to fourth videos 20 to 40), and may obtain a plurality of adjusted videos whose image quality has been adjusted (e.g., a first adjusted video 10′, a second adjusted video 20′, a third adjusted video 30′, and a fourth adjusted video 40′) by applying the sharpness enhancement strength to each of the reference video (e.g., the first video 10) and the remaining videos (e.g., the second to fourth videos 20, 30, to 40). In such an example, the processing module 200 of the electronic device 1000 may obtain the plurality of first to fourth adjusted videos 10′ to 40′ having uniform image quality by performing contrast, color tone, and sharpness processing on all frames of each video. The electronic device 1000 may generate an edited video (hereinafter, referred to as a combined video) in which a sense of incongruity is minimized by combining the plurality of first to fourth adjusted videos 10′ to 40′ whose image quality has been adjusted.

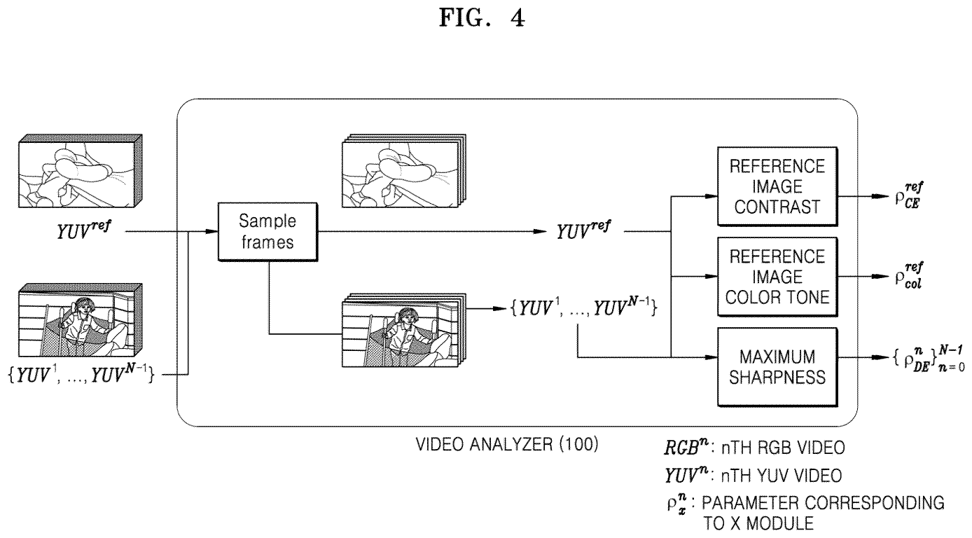

FIG. 4 is a diagram of an operation in which the electronic device 1000 may analyze a plurality of videos, according to an embodiment of the present disclosure.

Referring to FIG. 4, according to an embodiment of the present disclosure, the electronic device 1000 may convert each of a plurality of videos RGBⁿ selected by a user into videos YUVⁿ of a YUV format, and may extract sample frames by sampling each of the plurality of videos YUVⁿ converted into the YUV format. The electronic device 1000 may input the sample frames to the video analyzer 100.

The electronic device 1000, according to an embodiment of the present disclosure, may determine one video of the plurality of videos YUVⁿ as a reference video YUV^{ref} according to a certain criterion. For example, the electronic device 1000 may determine a first order video as the reference video YUV^{ref}, and/or may determine a video selected by the user as the reference video YUV^{ref}.

The video analyzer 100 of the electronic device 1000 may determine a contrast score

$${ρ}_{CE}^{ref}$$

of the reference video YUV^{ref} and a color tone

$${ρ}_{c o l}^{ref}$$

of the reference video YUV^{ref} by analyzing sample frames of the reference video YUV^{ref}. Alternatively or additionally, the video analyzer 100 of the electronic device 1000 may determine a sharpness of each of the reference video YUV^{ref} and the remaining videos YUV¹, . . . , YUV^{N-1}, and may determine a maximum sharpness

$${\{ {ρ}_{D E}^{n} \}}_{n = 0}^{N - 1}$$

from among the sharpness values. For example, the video analyzer 100 may determine the contrast score and the sharpness by using a Y channel of the sample frames, and may determine the color tone by using the Y channel, a U channel, and a V channel of the sample frames.

Although an example where the plurality of videos RGBⁿ are converted into the videos YUVⁿ of a YUV format is described with reference to FIG. 4, embodiments of the present disclosure are not limited thereto. For example, the electronic device 1000 may convert the plurality of videos RGBⁿ into videos of a YCbCr format, videos of a LAB format, videos of an HSV format, or the like.

Hereinafter, an example of an operation of the video analyzer 100 is described with reference to FIGS. 5 to 7.

FIG. 5 is a diagram of an operation in which the electronic device 1000 obtains contrast information of a reference video, according to an embodiment of the present disclosure.

Referring to FIG. 5, the electronic device 1000, according to an embodiment of the present disclosure, may determine a contrast score of a reference video by using an intensity value of a Y channel yⁿ of sample frames included in the reference video.

For example, the electronic device 1000 may divide each sample frame into patches (operation S510). The patch may be and/or may include an area larger than a pixel and may include a plurality of pixels. The electronic device 1000 may calculate a contrast Cᵢ for each patch Pᵢ (operation S520). The contrast of each patch may be determined according to an equation that may be represented as an equation similar to Equation 1. That is, the contrast Cᵢ of each patch may be a value obtained by dividing a difference between a maximum intensity value (max pᵢ) and a minimum intensity value (min pᵢ) in each patch by a sum of the maximum intensity and the minimum intensity.

$${C}_{i} = \frac{max {p}_{i} - min {p}_{i}}{max {p}_{i} + min {p}_{i}} \qquad [ Equation l ]$$

The electronic device 1000 may calculate the contrast of each patch for each sample frame, and may calculate a contrast average

$$( = \frac{1}{P} {\sum }_{i = 0}^{p - 1} {c}_{i} )$$

(operation S530). The contrast average may be a contrast of each sample frame. Accordingly, when there are a plurality of sample frames, the electronic device 1000 may determine an average of contrasts of the sample frames as a contrast score

$${ρ}_{CE}^{ref}$$

of the reference video.

FIG. 6 is a diagram of an operation in which the electronic device 1000 obtains color tone information of a reference video, according to an embodiment of the present disclosure.

Referring to FIG. 6, the electronic device 1000 may include a statistics module 610 for obtaining the color tone information of a reference video. In an embodiment of the present disclosure, the statistics module 610 may be physically implemented by analog and/or digital circuits including one or more of a logic gate, an integrated circuit, a microprocessor, a microcontroller, a memory circuit, a passive electronic component, an active electronic component, an optical component, and the like. For example, an FPGA may be used to implement custom logic that may include the functionality of the statistics module 610. As another example, a processor (e.g., of the electronic device 1000) in combination with a memory may be used to execute one or more instructions to perform the functionality of the statistics module 610. Alternatively or additionally, at least a portion of the functionality of statistics module 610 may be incorporated into the processing module 200 and/or implemented as instructions to be executed by the processing module 200.

As shown in FIG. 6, the statistics module 610 of the electronic device 1000 may calculate an average μ^{ref} and a standard deviation σ^{ref} for each channel (Y, U, V) of each sample frame in order to obtain overall color tone information

$${ρ}_{c o l}^{ref}$$

of a reference video YUV^{ref} For example, the statistics module 610 may generate a histogram based on intensity values of a Y channel y^{ref} 601, a U channel u^{ref} 602, and a V channel v^{ref} 603. In an embodiment, the Y channel y^{ref} 601, the U channel u^{ref} 602, and the V channel v^{ref} 603 may be referred to as a Y channel image, a U channel image, and a V channel image, respectively. The statistics module 610 may obtain an average

$${μ}_{y}^{ref}$$

and a standard deviation

$${σ}_{y}^{ref}$$

of the Y channel y^{ref} 601 based on a pixel value of the Y channel 601. The statistics module 610 may obtain an average

$${μ}_{u}^{ref}$$

and a standard deviation

$${σ}_{u}^{ref}$$

of the U channel u^{ref} 602 based on a pixel value of the U channel 602. The statistics module 610 may obtain an average

$${μ}_{v}^{ref}$$

and a standard deviation

$${σ}_{v}^{ref}$$

of the V channel v^{ref} 603 based on a pixel value of the V channel 603. As such, the color tone information

$${ρ}_{c o l}^{ref}$$

of the reference video may be expressed using the average and the standard deviation of the Y channel 601, the average and the standard deviation of the U channel 602, and the average and the standard deviation of the V channel 603. For example, the color tone information

$${ρ}_{c o l}^{ref}$$

of the reference video may be expressed as:

$${ρ}_{c o l}^{ref} = [ ( {μ}_{y}^{ref} , {σ}_{y}^{ref} ) , ( {μ}_{u}^{ref} , {σ}_{u}^{ref} ) , ( {μ}_{v}^{ref} , {σ}_{v}^{ref} ) ]$$

When there are a plurality of sample frames, an average of color tone information of the sample frames may be the color tone information

$${ρ}_{c o l}^{ref}$$

of the reference video.

FIG. 7 is a diagram of an operation in which the electronic device 1000 obtains a sharpness enhancement strength of each video, according to an embodiment of the present disclosure.

Referring to operation 701 of FIG. 7, the electronic device 1000 may calculate a sharpness of each of a plurality of videos selected by a user.

For example, the electronic device 1000 may extract a low-frequency image G(yⁿ) corresponding to each sample frame by applying a Gaussian blur to a Y channel yⁿ of each sample frame included in the plurality of videos. The electronic device 1000 may detect an edge area y^{hf} in the Y channel of each sample frame by using an absolute difference between the low-frequency image G(yⁿ) and the Y channel yₙ of each sample frame. The edge area y^{hf} in the Y channel may be represented as an equation similar to Equation 2.

$${y}^{hf} = \vert {y}^{n} - G ( {y}^{n} ) \vert \qquad [ Equation 2 ]$$

The electronic device 1000 may extract a sharpness enhancement target (true positive) mask m^{hf} for excluding a noise (false positive) area from the edge area y^{hf}. For example, the electronic device 1000 may remove noise caused by dots (⋅) in the edge area by using a kernel Ky. That is, the electronic device 1000 may perform a convolution operation between the edge area y^{hf} and the kernel K_{H}. The electronic device 1000 may determine a portion of the edge area having an intensity less than a threshold intensity t as noise, may remove the noise, and may extract the sharpness enhancement target mask m^{hf}. For example, the sharpness enhancement target mask m^{hf} may be represented as an equation similar to Equation 3.

$${m}^{hf} = \vert ( {y}^{hf} * {K}_{H} ) \geq τ \vert , where {K}_{H} = [ \begin{matrix}1 & 1 & 1 \\ 1 & 0 & 1 \\ 1 & 1 & 1\end{matrix} ] \qquad [ Equation 3 ]$$

The electronic device 1000 may obtain a sharpness of each sample frame by averaging edge scores of the edge areas from which the noise is removed. For example, the electronic device 1000 may calculate a sharpness score Sⁿ of each sample frame, by dividing a sum of values obtained by multiplying the edge area y^{hf} having an intensity value by the sharpness enhancement target mask m^{hf} by an area of the sample frame (H*W). When each video includes a plurality of sample frames, the electronic device 1000 may calculate an average of sharpness scores of the sample frames as a sharpness of the video, which may be represented as an equation similar to Equation 4.

$${S}^{n} = \frac{1}{H * W} {\sum }_{i = 0}^{HW - 1} {m}^{hf} \cdot {y}^{hf} ( H = height , W = width ) \qquad [ Equation 4 ]$$

Referring to operation 702 of FIG. 7, the electronic device 1000 may determine a maximum value S from among the sharpness scores Sⁿ extracted from each video. The electronic device 1000 may calculate a sharpness enhancement strength {ρ⁰, . . . , ρ^{N-1}} appropriate for each video by using the sharpness score Sⁿ of each video and the maximum value S. For example, the electronic device 1000 may determine the sharpness enhancement strength of each video by using an equation similar to Equation 5.

$${ρ}^{n} = λ \cdot \frac{s}{{s}^{n}} - k , \qquad [ Equation 5 ]$$

where S=max {s⁰, . . . , s^{N-1}} and λ, k are constants

A sharpness enhancement strength of each video may be a parameter for enhancing a sharpness of each video. For example, a sharpness enhancement strength of a reference video may be a parameter for enhancing a sharpness of the reference video. The electronic device 1000 may enhance the sharpness of the reference video based on the sharpness enhancement strength of the reference video, and may enhance the sharpness values of the remaining videos based on the sharpness enhancement strengths of the remaining videos.

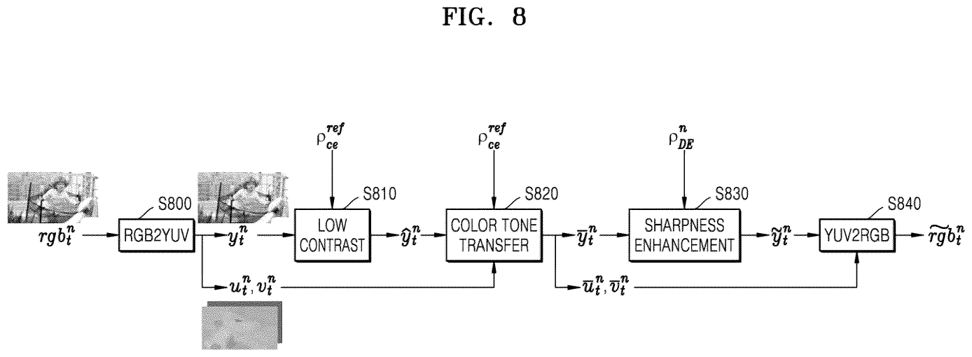

Hereinafter, an operation in which the electronic device 1000 adjusts the image quality of a plurality of videos by using an image quality-related parameter of a reference video obtained through the video analyzer 100 is described with reference to FIG. 8.

FIG. 8 is a diagram of an operation in which the electronic device 1000 adjusts the image quality of a plurality of videos, according to an embodiment of the present disclosure.

Referring to FIG. 8, the electronic device 1000 may convert each of a plurality of videos

$${rgb}_{t}^{n}$$

into a YUV format (operation S800). The processing module 200 of the electronic device 1000 may sequentially perform contrast adjustment processing (operation S810), color tone transfer processing (operation S820), and sharpness enhancement processing (operation S830) for each video converted into the YUV format. However, the processing order of the contrast adjustment processing (operation S810), the color tone transfer processing (operation S820), and the sharpness enhancement processing (operation S830) may be changed. Hereinafter, for convenience of explanation, the following description assumes that processing is performed in the order of the contrast adjustment processing (operation S810), the color tone transfer processing (operation S820), and the sharpness enhancement processing (operation S830). However, embodiments of the present disclosure are not limited in this regard, and the number of processing operations to be performed may vary as well as the order in which the processing operations may be performed without departing from the scope of the present disclosure.

According to an embodiment of the present disclosure, the electronic device 1000 may perform the contrast adjustment processing (operation S810), the color tone transfer processing (operation S820), and the sharpness enhancement processing (operation S830) on all frames of each video. For example, the electronic device 1000 may apply the contrast adjustment processing (operation S810) and the sharpness enhancement processing (operation S830) to a Y channel

$${y}_{t}^{n}$$

of each frame and may apply the color tone transfer processing (operation S820) on the Y channel

$${y}_{t}^{n} ,$$

a u channel

$${u}_{t}^{n} ,$$

and a V channel

$${v}_{t}^{n}$$

of each frame.

According to an embodiment of the present disclosure, the electronic device 1000 may perform the contrast adjustment processing (operation S810) on the Y channel

$${y}_{t}^{n}$$

of all frames included in each video. For example, the electronic device 1000 may perform the contrast adjustment processing (operation S810) on the Y channel

$${y}_{t}^{n}$$

of the remaining videos other than a reference video from among a plurality of videos selected by a user, based on a contrast score

$${ρ}_{CE}^{ref}$$

of the reference video. The electronic device 1000 may perform the color tone transfer processing (operation S820) on the Y channel

$${\hat{y}}_{t}^{n}$$

whose contrast is adjusted, the U channel

$${u}_{t}^{n} ,$$

and the V channel

$${v}_{t}^{n} .$$

For example, the electronic device 1000 may perform the color tone transfer processing (operation S820) on all frames included in the remaining videos, based on color tone information

$${ρ}_{col}^{ref}$$

of the reference video.

In addition, the electronic device 1000 may perform the sharpness enhancement processing (operation S830) on the Y channel

$${\overline{y}}_{t}^{n}$$

on which the color tone transfer processing (operation S820) has been performed. For example, the electronic device 1000 may perform the sharpness enhancement processing (operation S830) on the Y channel

$${\overline{y}}_{t}^{n}$$

of each video, based on a sharpness enhancement strength

$${ρ}_{col}^{ref} .$$

For example, in the case of the reference video, the electronic device 1000 may perform the sharpness enhancement processing (operation S830) on an original Y channel

$${y}_{t}^{ref}$$

to which contrast adjustment and color tone transfer are not applied.

When the contrast adjustment processing (operation S810), the color tone transfer processing (operation S820), and the sharpness enhancement processing (operation S830) are completed, the electronic device 1000 may convert a YUV video

$$( {\tilde{y}}_{t}^{n} , {\overline{u}}_{t}^{n} , {\overline{v}}_{t}^{n} )$$

into a RGB video

(operation S840). According to an embodiment of the present disclosure, the electronic device 1000 may combine and edit RGB videos into one video. Alternatively or additionally, the electronic device 1000 may combine and edit YUV videos into one video, and then may convert the one video into an RGB video.

Although the electronic device 1000 adjusts a contrast, a color tone, and a sharpness in order to uniformly adjust the image quality of a plurality of videos in FIG. 8, embodiments of the present disclosure are not limited thereto. For example, the electronic device 1000 may further adjust at least one of a brightness, an exposure, a saturation, a color temperature, a clarity, or the like, in order to uniformly adjust the image quality of the plurality of videos.

Hereinafter, each of the contrast adjustment processing (operation S810), the color tone transfer processing (operation S820), and the sharpness enhancement processing (operation S830) is further described with reference to FIGS. 9 to 12.

FIG. 9 is a diagram of an operation in which the electronic device 1000 adjusts a contrast of each video, according to an embodiment of the present disclosure.

FIG. 9 is described assuming that the electronic device 1000 adjusts a contrast for one frame included in a plurality of videos. The one frame is a frame to be currently processed and may be referred to as an input image. The contrast adjustment for the input image may be equally applied to other frames included in the plurality of videos.

Referring to FIG. 9, the electronic device 1000 may reduce and/or enhance a contrast of an input image

$${y}_{t}^{n}$$

according to a comparison result between a contrast score of the input image

$${y}_{t}^{n}$$

and a contrast score of a reference video y^{ref}. For example, the electronic device 1000 may calculate a contrast score

$${ρ}_{CE}^{n}$$

of the input image (operation S910), and may compare the contrast score of the input image with a contrast score

$${ρ}_{CE}^{ref}$$

of the reference video (operation S920). The contrast score of the input image may be calculated according to the method described with reference to FIG. 5. When the contrast score of the input image is greater than the contrast score of the reference video

$$( {ρ}_{C E}^{n} > {ρ}_{C E}^{ref} )$$

as a comparison result (Yes in operation S920), the electronic device 1000 may reduce the contrast of the input image (operation S931). For example, the electronic device 1000 may reduce the contrast of the input image by blending the input image with a gray image (operation S931).

According to an embodiment of the present disclosure, when the contrast score of the input image is less than the contrast score of the reference video

$$( {ρ}_{C E}^{n} < {ρ}_{C E}^{ref} )$$

(No in operation S920), the electronic device 1000 may enhance the contrast of the input image (operation S940). For example, the electronic device 1000 may divide the input image into patches Pₖ (operation S941). A patch may be and/or may include an area larger than a pixel and may include a plurality of pixels. The electronic device 1000 may calculate a histogram hₖ 901 corresponding to each patch (operation S942). That is, the electronic device 1000 may generate the histogram 901 by counting an intensity value included in each patch. The electronic device 1000 may calculate a clip value Ck 902 for each histogram hₖ 901, by using an equation similar to Equation 6 (operation S943). According to Equation 6, the clip value 902 of each histogram 901 may be calculated as a value obtained by dividing an absolute deviation between an intensity value of a center pixel in each patch and a mean intensity value of each patch by a standard deviation of intensity values of each patch.

$${C}_{k} = λ \cdot \frac{\vert {y}_{k}^{c} - {μ}_{k} \vert}{{σ}_{k}} , \qquad [ Equation 6 ]$$

where

$${y}_{k}^{c}$$

is the intensity value or the center pixel in patch Pₖ
   μₖ, σₖ are mean and standard deviation of intensity values patch Pₖ
   λ is some constant

The electronic device 1000 may clip bins of the histogram 901 counted more than the clip value 902 and distribute the bins to other bins (operation S944). When the bins are distributed, the number of bins having the same intensity value may be reduced. In this case, the electronic device 1000 may generate a new histogram 903 by uniformly filling bins of the histogram 901 counted more than the clip value 902 starting from the lower end of other bins. The electronic device 1000 may generate a cumulative distribution function cdfₖ 904 by accumulating the distributed histogram 903 (operation S945), and may use the cumulative distribution function 904 as a mapping function. Hereinafter, the cumulative distribution function 904 may be referred to as a mapping function. In the cumulative distribution function 904, the x-axis may represent an input intensity value and the y-axis may represent an output intensity value.

According to an embodiment of the present disclosure, the electronic device 1000 may enhance the contrast of the input image by interpolating mapping functions around each pixel of the input image (operation S946), which is described with reference to FIG. 10.

FIG. 10 is a diagram of an operation in which the electronic device 1000 interpolates mapping functions around a corresponding pixel, according to an embodiment of the present disclosure.

According to an embodiment of the present disclosure, when an intensity value of the corresponding pixel is determined by using only a mapping function of a patch including the corresponding pixel, unnaturalness may occur at a patch boundary. Accordingly, the electronic device 1000 may determine an intensity value of the corresponding pixel by interpolating mapping functions around the corresponding pixel.

For example, referring to FIG. 10, an intensity value of a current pixel 1001 may be determined by interpolating mapping functions (e.g., a first mapping function 1011, a second mapping function 1021, a third mapping function 1031, and a fourth mapping function 1041) of patches (e.g., a first patch 1010, a second patch 1020, a third patch 1030, and a fourth patch 1040) located around the current pixel 1001. Referring to 1000-1 of FIG. 10, the electronic device 1000 may determine a weight wₖ of each patch by considering a spatial distance between the current pixel and a center of each neighboring patch. The weight wₖ may be determined to be smaller as the distance between the current pixel and the center of each neighboring patch increases. A first weight w₁ may be determined based on a distance between the current pixel 1001 and a first center p₁ of the first patch 1010 including the current pixel 1001. A second weight w₂ may be determined based on a distance between the current pixel 1001 and a second center p₂ of the second patch 1020 located to the right side of the first patch 1010. A third weight w₃ may be determined based on a distance between the current pixel 1001 and a third center p₃ of the third patch 1030 located below the first patch 1010. A fourth weight w₄ may be determined based on a distance between the current pixel 1001 and a fourth center p₄ of the fourth patch 1040 located at the lower-right of the first patch 1010.

Referring to 1000-2 of FIG. 10, the electronic device 1000 may determine a value obtained by mapping an intensity value of the current pixel 1001 through a mapping function for each patch. For example, the electronic device 1000 may determine a first intensity value z₁ corresponding to an intensity value of the current pixel 1001, by using the first mapping function 1011 of the first patch 1010. The electronic device 1000 may determine a second intensity value z₂ corresponding to the intensity value of the current pixel 1001, by using the second mapping function 1021 of the second patch 1020. The electronic device 1000 may determine a third intensity value z₃ corresponding to the intensity value of the current pixel 1001, by using the third mapping function 1031 of the third patch 1030. The electronic device 1000 may determine a fourth intensity value z₄ corresponding to the intensity value of the current pixel 1001, by using the fourth mapping function 1041 of the fourth patch 1040.

The electronic device 1000 may determine the intensity value of the current pixel 1001 by summing products of the weight values wₖ and output values zₖ of the patches, and may obtain an input image whose contrast is enhanced by constructing an image using the intensity values of the pixels, and may be represented as an equation similar to Equation 7.

$$\hat{y} [ i , j ] = {\sum }_{k} {w}_{k} \cdot {z}_{k} \qquad [ Equation 7 ]$$

Although mapping functions of four (4) patches are interpolated in FIG. 10, embodiments of the present disclosure are not limited thereto. For example, the electronic device 1000 may interpolate mapping functions of additional patches (e.g., more than four (4), such as nine (9)) or may interpolate mapping functions of less patches (e.g., less than four (4), such as two (2)) around the current pixel.

FIG. 11 is a diagram of an operation in which the electronic device 1000 transfers a color tone of each video, according to an embodiment of the present disclosure.

According to an embodiment of the present disclosure, the electronic device 1000 may transfer a color tone of a reference video to the remaining videos. To this end, the electronic device 1000 may calculate an average and a standard deviation for each channel (Y, U, V) of each video (operation S1110). For example, the electronic device 1000 may generate a histogram for each channel of each video, and may calculate an average and a standard deviation. The electronic device 1000 may apply normalization by using an average and a standard deviation of the reference video for each channel (Y, U, V) (operation S1120). For example, the electronic device 1000 may normalize data of each channel of a current video, by using a channel-wise average and standard deviation of a video to be currently processed (current video) and a channel-wise average and standard deviation of the reference video. Referring to 1101 of FIG. 11, data of a Y channel of the current video may be normalized so that an average

$${u}_{y}^{n}$$

of the channel of the current video approaches (e.g., is substantially similar and/or the same as) an average

$${μ}_{y , t}^{ref}$$

of a Y channel of the reference video. For example, the electronic device 1000 may normalize data of each channel, by subtracting an average of each channel from data of the channel, multiplying a result by a standard deviation of the reference video divided by a standard deviation of the channel, and adding an average of the reference video according to Equation 8.

$${x}_{t}^{′ n} = \frac{{σ}_{x}^{r e f}}{{σ}_{x , t}^{n}} ( {x}_{t}^{n} - {μ}_{x}^{r e f} ) + {μ}_{x}^{r e f} wh ere \\ x ∈ \{ y , u , v \} and {ρ}_{c o l}^{r e f} = \{ {μ}_{x}^{r e f} , {σ}_{x}^{r e f} \} \qquad [ Equation 8 ]$$

According to an embodiment of the present disclosure, the electronic device 1000 may apply blending so that a difference between an input image (currently processed frame) and a normalized image is appropriately reflected (operation S1130). For example, the electronic device 1000 may transfer color tone information of the reference video to the current video by blending data of each channel of the current video with normalized data of each channel of the current video, based on a difference between the channel-wise average of the current video and the channel-wise average of the reference video.

According to an embodiment of the present disclosure, the electronic device 1000 may blend data (image) of each channel with normalized data (image) of each channel, according to an equation similar to Equation 9. For example, when a difference between the channel-wise average of the current video and the channel-wise average of the reference video is less than a first threshold value τ₀, the electronic device 1000 may blend data of each channel of the current video with normalized data of each channel of the current video at a ratio of 3:1. Alternatively, when the difference between the channel-wise average of the current video and the channel-wise average of the reference video gradually increases, a blending ratio of normalized data may decrease. When the difference between the channel-wise average of the current video and the channel-wise average of the reference video exceeds a second threshold value 11, data of each channel may be output without being blended with normalized data. That is, when a color tone change is too large compared to an original video, a user may feel a strong sense of incongruity, and thus, the electronic device 1000 may blend data (image) of each channel with normalized data (image) of each channel at an appropriate ratio.

$${\tilde{x}}_{t}^{n} = a {x}_{t}^{n} + ( 1 - α ) {x}_{t}^{′ n} , where α = \{ \begin{matrix}0.75 & if {ℒ}_{1} ( \cdot ) \leq {τ}_{0} \\ m \cdot {ℒ}_{1} ( \cdot ) + k & {τ}_{0} < {ℒ}_{1} ( \cdot ) \leq {τ}_{1} \\ 1. & {τ}_{0} < {ℒ}_{1} ( \cdot )\end{matrix} , for {ℒ}_{1} ( \cdot ) = {ℒ}_{1} ( {μ}^{r e f} , {μ}_{x , t}^{n} ) = {\sum }_{∀ x} \vert {μ}_{x}^{r e f} - {μ}_{x , t}^{n} \vert , and \qquad [ Equation 9 ]$$

τ₀, τ₁, m, and k are constants

According to an embodiment of the present disclosure, when the reference video is yellowish, the remaining videos may also be adjusted to be yellowish.

Although a YUV color space is used in FIG. 11, embodiments of the present disclosure are not limited thereto. The electronic device 1000 may use a YCbCr color space, a LAB color space, an HSV color space, or the like. For example, when the electronic device 1000 uses a YCbCr color space, normalization may be applied by using the average and the standard deviation of the reference video to each channel (Y channel, Cb channel, and Cr channel) of each video. When the electronic device 1000 uses a LAB color space, normalization may be applied by using the average and the standard deviation of the reference video to each channel (L channel, a channel, and b channel) of each video. When the electronic device 1000 uses an HSV color space, normalization may be applied by using the average and the standard deviation of the reference video to each channel (H channel, S channel, and V channel) of each video.

FIG. 12 is a diagram of an operation in which the electronic device 1000 enhances a sharpness of each video, according to an embodiment of the present disclosure.

According to an embodiment of the present disclosure, the electronic device 1000 may enhance a sharpness of each video, based on a sharpness enhancement strength (sharpness score) of each video calculated according to the process described with reference to FIG. 7.

FIG. 12 is described assuming that the electronic device 1000 adjusts a sharpness for one frame included in a plurality of videos. The one frame is a frame to be currently processed and may be referred to as an input image. The sharpness adjustment for the input image may be equally applied to other frames included in the plurality of videos.

The electronic device 1000 may extract a low-frequency image G(yⁿ) corresponding to the input image by applying a Gaussian blur to a Y channel

$${\overline{y}}_{t}^{n}$$

of the input image (operation S1210). The electronic device 1000 may detect an edge area G(yⁿ) in the Y channel of the input image by using an absolute difference between the low-frequency image G(yⁿ) and the Y channel

$${\overline{y}}_{t}^{n}$$

of the input image (operation S1220), which may be represented as an equation similar to Equation 10.

$${y}^{h f} = \vert {\overline{y}}_{t}^{n} - G ( {y}^{n} ) \vert \qquad [ Equation 10 ]$$

The electronic device 1000 may extract a sharpness enhancement target (true positive) mask m^{hf} for excluding a noise (false positive) area from the edge area y^{hf}. For example, the electronic device 1000 may remove noise caused by dots (⋅) by using a kernel K_{H}. That is, the electronic device 1000 may perform a convolution operation between the edge area y^{hf} and the kernel K_{H}. The electronic device 1000 may determine a portion of the edge area having an intensity less than a threshold intensity t as noise, may remove the noise, and may extract the sharpness enhancement target mask m^{hf} (operation S1230), which may be represented as an equation similar to Equation 11.

$${m}^{h f} = \vert ( {y}^{h f} * {K}_{H} ) \geq τ \vert , where {K}_{H} = [ \begin{matrix}1 & 1 & 1 \\ 1 & 0 & 1 \\ 1 & 1 & 1\end{matrix} ] \qquad [ Equation 11 ]$$

According to an embodiment of the present disclosure, the electronic device 1000 may apply a sharpness enhancement strength to the edge area from which the noise is removed (operation S1240). For example, the sharpness enhancement strength may be multiplied by a product of the edge area y^{hf} and the sharpness enhancement target mask m^{hf}. The electronic device 1000 may obtain an image whose sharpness is enhanced by adding the edge area, to which the sharpness enhancement strength

$${ρ}_{D E}^{n}$$

is applied, to the input image according to an equation similar to Equation 12 (operation S1250). The electronic device 1000 may enhance a sharpness by enhancing an edge of each frame based on a sharpness enhancement strength.

$${\tilde{y}}_{t}^{n} = {y}_{y}^{n} + {ρ}_{D E}^{n} \cdot ( {m}^{h f} ⊙ {y}^{h f} ) \qquad [ Equation 12 ]$$

Although a YUV color space is used in FIG. 12, embodiments of the present disclosure are not limited thereto. The electronic device 1000 may use a YCbCr color space, a LAB color space, or an HSV color space. For example, the electronic device 1000 may use an L channel (in the case of the LAB color space) of the input image or a V channel (in the case of the HSV color space) of the input image, instead of the Y channel of the input image.

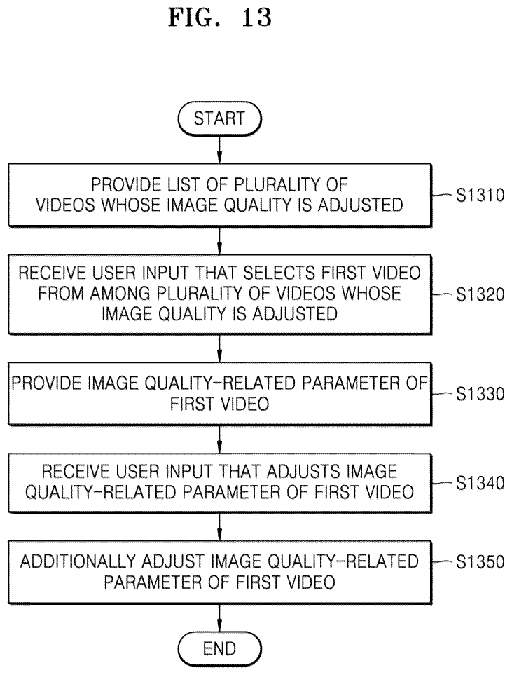

According to an embodiment of the present disclosure, a user may additionally adjust image quality for a plurality of videos whose contrast, color tone, and sharpness are automatically adjusted by the electronic device 1000. Hereinafter, a method by which the electronic device 1000 additionally adjusts the image quality of a video according to a user input is described with reference to FIG. 13.

FIG. 13 is a flowchart of a method by which the electronic device 1000 additionally adjusts the image quality of a video according to a user input, according to an embodiment of the present disclosure.

Referring to FIG. 13, the method by which the electronic device 1000 additionally adjusts the image quality of a video may include operations S1310 to S1350. In an embodiment of the present disclosure, operations S1310 to S1350 may be executed by at least one processor included in the electronic device 1000. The method by which the electronic device 1000 additionally adjusts the image quality of a video is not limited to that illustrated in FIG. 13, and in one or more embodiments of the present disclosure, operations not shown in FIG. 13 may be further included or some operations may be omitted.

In operation S1310, the electronic device 1000, according to an embodiment of the present disclosure, may provide a list of a plurality of videos whose image quality is adjusted.

According to an embodiment of the present disclosure, when contrast, color tone, or sharpness adjustment for a plurality of videos selected by a user is completed, the electronic device 1000 may output a list of the plurality of videos whose image quality is adjusted to a screen. According to an embodiment of the present disclosure, the electronic device 1000 may provide the list of the plurality of videos together with a combined video in which the plurality of videos are combined into one, or may provide the list of the plurality of videos when the user requests to edit the combined video.

According to an embodiment of the present disclosure, a thumbnail image or a representative frame of each video may be displayed in the list of the plurality of videos whose image quality is adjusted, but the present disclosure is not limited thereto.

In operation S1320, the electronic device 1000, according to an embodiment of the present disclosure, may receive a user input that selects a first video from among the plurality of videos whose image quality is adjusted. For example, the electronic device 1000 may receive an input that touches a thumbnail image of the first video for a certain period of time or more or a certain number of times or more in the list of the plurality of videos whose image quality is adjusted.

That is, the user may select one video, for which the user wants to check an image quality-related parameter, from among the plurality of videos whose image quality is adjusted.

In operation S1330, the electronic device 1000, according to an embodiment of the present disclosure, may provide an image quality-related parameter of the first video, based on a user input that selects the first video. For example, the electronic device 1000 may provide a parameter related to a contrast, a color tone, or a sharpness of the first video whose image quality is adjusted.

According to an embodiment of the present disclosure, the electronic device 1000 may display a contrast icon, a color tone icon, and a sharpness icon in relation to the first video, and may provide a specific parameter according to an input that selects one of the icons. For example, the electronic device 1000 may display a contrast score of the first video when receiving an input that selects the contrast icon, may display color tone information of the first video when receiving an input that selects the color tone icon, and may display a sharpness enhancement strength (sharpness score) of the first video when receiving an input that selects the sharpness icon.

In operation S1340, the electronic device 1000, according to an embodiment of the present disclosure, may receive a user input that adjusts the image quality-related parameter of the first video.

According to an embodiment of the present disclosure, the electronic device 1000 may receive a user input that adjusts at least one of the contrast, the color tone, or the sharpness of the first video. For example, the electronic device 1000 may receive an input that increases or reduces the contrast of the first video, an input that changes the color tone of the first video, or an input that increases or reduces the sharpness enhancement strength.

Also, according to an embodiment of the present disclosure, the electronic device 1000 may receive an input that turns on/off each processing module. For example, the electronic device 1000 may receive an input that deactivates and/or activates a contrast adjustment module, an input that deactivates and/or activates a color tone adjustment module, or an input that deactivates and/or activates a sharpness adjustment module.

In operation S1350, the electronic device 1000, according to an embodiment of the present disclosure, may additionally adjust the image quality-related parameter of the first video, based on a user input that adjusts the image quality-related parameter of the first video.

According to an embodiment of the present disclosure, the electronic device 1000 may additionally adjust the image quality of the first video whose image quality is automatically adjusted, when receiving an input that adjusts the image quality-related parameter of the first video from the user.

For example, when the electronic device 1000 receives an input that adjusts the contrast score of the first video from the user, the electronic device 1000 may apply a contrast score selected by the user to each frame included in the first video. Alternatively or additionally, when the electronic device 1000 receives an input that deactivates the contrast adjustment module from the user, the electronic device 1000 may return the contrast of each frame of the first video to its original state.

According to an embodiment of the present disclosure, when the image quality of the first video is additionally adjusted, the electronic device 1000 may perform editing by combining the first video whose image quality is additionally adjusted with the remaining videos into one video.

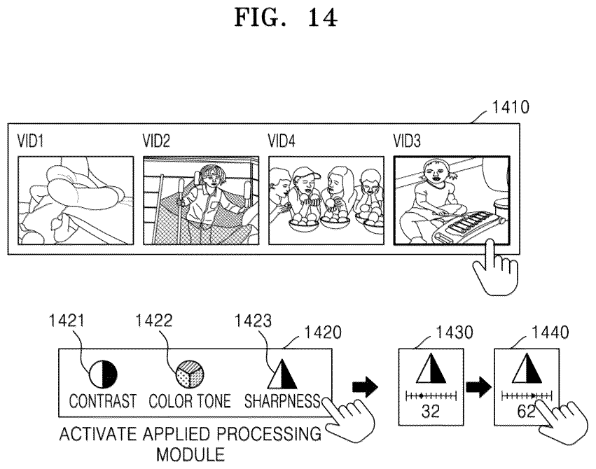

Accordingly, according to an embodiment of the present disclosure, the user may additionally modify an image quality-related parameter of each video that has been automatically adjusted. An operation in which the electronic device 1000 additionally adjusts the image quality of a video according to a user input is further described with reference to FIG. 14.

FIG. 14 is a diagram of an operation in which the electronic device 1000 additionally adjusts the image quality of a video according to a user input, according to an embodiment of the present disclosure.

Referring to FIG. 14, the electronic device 1000 may provide a list 1410 of a plurality of videos whose image quality is adjusted. For example, the electronic device 1000 may provide the list 1410 including a first video VID1, a second video VID2, a fourth video VID4, and a third video VID3.

When a user selects the third video VID3 from the list 1410, the electronic device 1000 may provide an image quality-related parameter of the third video VID3. For example, the electronic device 1000 may provide a processing module list 1420 capable of adjusting the image quality of the third video. The processing module list 1420 may include a first icon 1421 indicating a contrast adjustment module, a second icon 1422 indicating a color tone adjustment module, and a third icon 1423 indicating a sharpness adjustment module. When the user selects the third icon 1423 indicating the sharpness adjustment module from the processing module list 1420, the electronic device 1000 may display an indicator (e.g., a value of 32) indicating a sharpness enhancement strength 1430 of the third video VID3. When the electronic device 1000 receives an input that adjusts the sharpness enhancement strength from the user, the electronic device 1000 may adjust a sharpness 1440 of the third video VID3. For example, when the electronic device 1000 receives an input that adjusts the indicator indicating the sharpness enhancement strength from 32 to 62, the electronic device 1000 may enhance the sharpness by reinforcing an edge of each frame of the third video VID3.

The electronic device 1000 may receive an input that deactivates some of the icons included in the processing module list 1420. For example, the electronic device 1000 may receive an input that deactivates the third icon indicating the sharpness adjustment module. In such an example, the electronic device 1000 may maintain the original sharpness without adjusting the sharpness of the third video VID3.

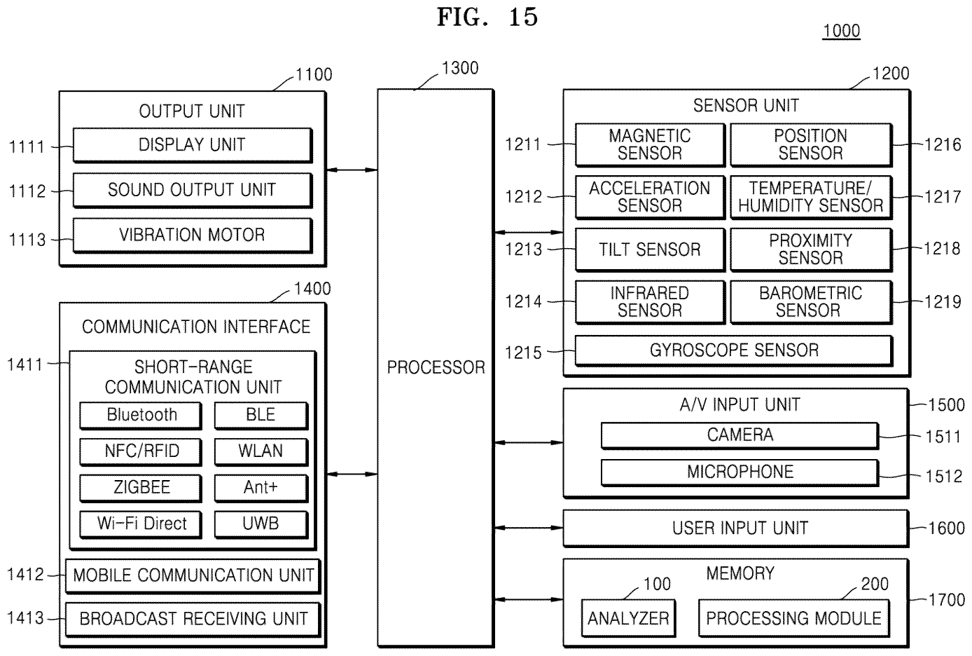

FIG. 15 is a block diagram of a function of the electronic device 1000, according to an embodiment of the present disclosure.

As shown in FIG. 15, the electronic device 1000, according to an embodiment of the present disclosure, may include an output unit 1100, a sensor unit 1200, a processor 1300, a communication interface 1400, an audio/video (A/V) input unit 1500, a user input unit 1600, and memory 1700.

The number and arrangement of components of the electronic device 1000 shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Alternatively or additionally, a set of (one or more) components shown in FIG. 15 may be integrated with each other, and/or may be implemented as an integrated circuit, as software, and/or a combination of circuits and software. For example, the memory 1700 and the processor 1300 may be combined into a single component or device.

The output unit 1100 for outputting an audio signal, a video signal, or a vibration signal may include a display unit 1111, a sound output unit 1112, and a vibration motor 1113.

When the display unit 1111 and a touch pad have a layer structure to form a touchscreen, the display unit 1111 may be used as an input interface in addition to an output interface. The display unit 1111 may include, but not be limited to, at least one of a liquid-crystal display unit, a thin-film transistor liquid-crystal display unit, an organic light-emitting diode, a flexible display unit, a three-dimensional (3D) display unit, or an electrophoretic display unit. Two (2) or more display units 1111 may be included according to an implementation type of the electronic device 1000.

The sound output unit 1112 may output an audio signal received from the communication interface 1400 and/or stored in the memory 1700. Alternatively or additionally, the sound output unit 1112 may output a sound signal related to a function (e.g., a call signal reception sound, a message reception sound, a notification sound, or the like) performed by the electronic device 1000. The sound output unit 1112 may include, but not be limited to, a speaker, a buzzer, or the like.

The vibration motor 1113 may output a vibration signal. For example, the vibration motor 1113 may output a vibration signal corresponding to an output of audio data or video data (e.g., a call signal reception sound, a message reception sound, or the like). Alternatively or additionally, the vibration motor 1113 may output a vibration signal when a touch is input to the touchscreen.

The sensor unit 1200 may include at least one of, but not be limited to, a magnetic sensor 1211, an acceleration sensor 1212, a tilt sensor 1213, an infrared sensor 1214, a gyroscope sensor 1215, a position sensor (e.g., a global positioning system (GPS)) 1216, a temperature/humidity sensor 1217, a proximity sensor 1218, or a biometric pressure sensor 1219. A function of each sensor may be intuitively inferred by one of ordinary skill in the art from its name, and thus, a detailed description thereof may be omitted for the sake of brevity.

The processor 1300 controls an overall operation of the electronic device 1000. For example, the processor 1300 may generally control the output unit 1100, the sensor unit 1200, the communication interface 1400, the A/V input unit 1500, the user input unit 1600, and the memory 1700, by executing programs stored in the memory 1700.

The processor 1300 may include one or more processors. The one or more processors included in the processor 1300 may be and/or may include circuitry such as, but not limited to, a system on chip (SoC), an integrated circuit (IC), or the like. The one or more processors included in the processor 1300 may be a general-purpose processor (e.g., a central processing unit (CPU), a microprocessor unit (MPU), an application processor (AP), a digital signal processor (DSP), or the like), a graphics-dedicated processor (e.g., a graphics processing unit (GPU), a vision processing unit (VPU), or the like), an artificial intelligence (AI)-dedicated processor (e.g., a neural processing unit (NPU)), a communication-dedicated processor (e.g., a communication processor (CP)), or the like. When the one or more processors included in the processor 1300 include AI-dedicated processors, the AI-dedicated processors may be designed with a hardware structure specialized for processing a specific AI model. The processor 1300 may be implemented as a single core processor or a multicore processor.

The processor 1300 may write data to the memory 1700 and/or may read data stored in the memory 1700, and particularly, may process data according to predefined operation rules and/or an AI model by executing a program or at least one instruction stored in the memory 1700.

The communication interface 1400 may include one or more components that may enable communication between the electronic device 1000 and an external device (e.g., an Internet-of-Things (IoT) device, a server, or the like). For example, the communication interface 1400 may include a short-range wireless communication unit 1411, a mobile communication unit 1412, and a broadcast receiving unit 1413.

Examples of the short-range wireless communication unit 1411 may include, but are not limited to, a Bluetooth™ communication unit, a Bluetooth™ low energy (BLE) communication unit, a near-field communication (NFC) unit, a wireless local area network (WLAN) communication unit (e.g., wireless-fidelity (Wi-Fi)), a ZigBee™ communication unit, an infrared data association (IrDA) communication unit, a Wi-Fi direct (WFD) communication unit, an ultra-wideband (UWB) communication unit, and an Ant+ communication unit.

The mobile communication unit 1412 may transmit and/or receive a wireless signal to and/or from at least one of a base station, an external terminal, or a server, on a mobile communication network. As used herein, the wireless signal may include, but not limited to, a voice call signal, a video call signal, or various types of data according to text/multimedia message transmission/reception.

The broadcast receiving unit 1413 may receive a broadcast signal and/or broadcast-related information from an external source through a broadcast channel. Examples of the broadcast channel may include, but may not be limited to, a satellite channel, a terrestrial channel, or the like. According to an embodiment of the present disclosure, the electronic device 1000 may not include the broadcast receiving unit 1413.

The A/V input unit 1500 for inputting an audio signal and/or a video signal may include a camera 1511 and a microphone 1512. The camera 1511 may obtain image frames such as, but not limited to, a still image and/or a moving image via an image sensor, in a video call mode, and/or an imaging mode. An image captured by the image sensor may be processed by the processor 1300 and/or a separate image processor. An image frame processed by the camera 1511 may be stored in the memory 1700 and/or may be transmitted to the outside through the communication interface 1400. According to an embodiment of the present disclosure, the camera 1511 may include at least one of, but not limited to, a telephoto camera, a wide-angle camera, or a standard camera.

The microphone 1512 may receive an external sound signal and may process the external sound signal into electrical voice data. For example, the microphone 1512 may receive a sound signal from an external device and/or a speaker. The microphone 1512 may use various noise removal algorithms for removing noise generated in a process of receiving an external sound signal.

The user input unit 1600 may refer to a device and/or a means by which a user may input data for controlling the electronic device 1000. Examples of the user input unit 1600 may include, but are not limited to, a keypad, a dome switch, a touch pad (e.g., capacitive type, pressure-sensitive resistive type, infrared (IR) detection type, surface acoustic wave type, integral tension measuring type, or piezoelectric effect type), a jog wheel, and a jog switch.

The memory 1700 may store a program for processing and/or control by the processor 1300, and may store input/output data (e.g., voice data, photo images, memo data, and biometric information of a user).

The memory 1700 may include at least one type of storage medium from among, but not limited to, a flash memory type, a hard disk type, a multimedia card micro type, a card type memory (e.g., secure digital (SD) or extreme digital (XD) memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, an optical disk, or the like.

The memory 1700 may not be separately present and may be included in the processor 1300. The memory 1700 may include a volatile memory, a non-volatile memory, or a combination of a volatile memory and a non-volatile memory. A program or at least one instruction for performing operations, according to an embodiment of the present disclosure, may be stored in the memory 1700. The memory 1700 may provide data stored data to the processor 1300 according to a request from the processor 1300.

According to an embodiment of the present disclosure, the memory 1700 may include the video analyzer 100 and the processing module 200. The video analyzer 100 may be a module for obtaining an image quality-related parameter (e.g., a contrast score, color tone information, a sharpness enhancement strength, a brightness, an exposure, a saturation, a color temperature, and a clarity), by analyzing an input video, as described above with reference to FIGS. 1 to 14. The processing module 200 may be a module for adjusting a contrast, a color tone, or a sharpness of each video. Also, the processing module 200 may be a module for adjusting a brightness, an exposure, a saturation, a color temperature, and a clarity of each video, as described above with reference to FIGS. 1 to 14.

According to an embodiment of the present disclosure, there may be provided the electronic device 1000 that may minimize a sense of incongruity of a combined video by automatically adjusting and combining an image quality-related parameter when a plurality of videos captured under different conditions are combined into one video.

A method of editing a video by the electronic device 1000, according to an embodiment of the present disclosure, may include receiving a user input that selects a plurality of videos to be edited into one video, determining a reference video from among the selected plurality of videos, obtaining an image quality-related parameter of the reference video by analyzing the reference video, obtaining a plurality of videos whose image quality is adjusted, by applying the image quality-related parameter of the reference video to each of the plurality of videos, and performing editing by combining the plurality of videos whose image quality is adjusted into one video.

The image quality-related parameter, according to an embodiment of the present disclosure, may include at least one of a contrast score, color tone information, or a sharpness enhancement strength. Also, the image quality-related parameter, according to an embodiment of the present disclosure, may include at least one of a brightness score, a saturation score, color temperature information, or a clarity score.

The method, according to an embodiment of the present disclosure, may include receiving a user input that adjusts a combination order from among the selected plurality of videos.

The determining of the reference video, according to an embodiment of the present disclosure, may include determining a first order video from among the plurality of videos as the reference video.

The determining of the reference video, according to an embodiment of the present disclosure, may include determining a video selected by a user from among the plurality of videos as the reference video.

The method, according to an embodiment of the present disclosure, may further include providing a list of the plurality of videos whose image quality is adjusted, based on receiving a user input that selects a first video from among the plurality of videos whose image quality is adjusted, providing an image quality-related parameter of the first video, and in response to receiving a user input that adjusts the image quality-related parameter of the first video, additionally adjusting the image quality-related parameter of the first video.

The obtaining of the image quality-related parameter of the reference video, according to an embodiment of the present disclosure, may include converting the plurality of videos including the reference video into a YUV format, and analyzing the reference video converted into the YUV format. The obtaining of the plurality of videos whose image quality is adjusted, according to an embodiment of the present disclosure, may include obtaining the plurality of videos whose image quality is adjusted, by applying the image quality-related parameter of the reference video to the plurality of videos converted into the YUV format, and converting the plurality of videos whose image quality is adjusted into an RGB format. The obtaining of the image quality-related parameter of the reference video, according to an embodiment of the present disclosure, may include converting the plurality of videos including the reference video into one of a YCbCr format, a LAB format, or a hue, saturation, value (HSV) format.

The obtaining of the image quality-related parameter of the reference video, according to an embodiment of the present disclosure, may include selecting sample frames from among all frames included in the reference video, and obtaining the image quality-related parameter of the reference video by analyzing the selected sample frames.

The obtaining of the image quality-related parameter of the reference video, according to an embodiment of the present disclosure, may include determining a contrast score of the reference video by using an intensity value of a Y channel of the sample frames included in the reference video. The obtaining of the plurality of videos whose image quality is adjusted, according to an embodiment of the present disclosure, may include applying the contrast score of the reference video to the plurality of videos.

The applying of the contrast score of the reference video to the plurality of videos, according to an embodiment of the present disclosure, may include determining a contrast score of a current video from among the plurality of videos, and when the contrast score of the current video is higher than the contrast score of the reference video, reducing a contrast of the current video by blending each frame included in the current video with a gray image.

The applying of the contrast score of the reference video to the plurality of videos, according to an embodiment of the present disclosure, may include determining a contrast score of a current video from among the plurality of videos, when the contrast score of the current video is lower than the contrast score of the reference video, dividing each frame of the current video into a plurality of patches, and obtaining a mapping function corresponding to each patch, and enhancing a contrast of the current video by determining an intensity value of a corresponding pixel included in each frame of the current video by using mapping functions corresponding to neighboring patches of the corresponding pixel.

The obtaining of the mapping function corresponding to each patch, according to an embodiment of the present disclosure may include obtaining a histogram corresponding to each patch, determining a clip value of each histogram by using a mean intensity value of each patch, a variance of intensity values of each patch, and an intensity value of a center pixel, obtaining a modified histogram by distributing bins of the histogram counted more than the clip value to other bins, and generating a cumulative distribution function by accumulating the modified histogram as the mapping function.

The enhancing of the contrast of the current video, according to an embodiment of the present disclosure, may include determining the intensity value of the corresponding pixel by interpolating the mapping functions by considering a spatial distance between the corresponding pixel and centers of the neighboring patches.

The obtaining of the image quality-related parameter of the reference video, according to an embodiment of the present disclosure, may include obtaining color tone information of the reference video by using an average and a standard deviation of each of a Y channel, a U channel, and a V channel of sample frames included in the reference video. The obtaining of the plurality of videos whose image quality is adjusted, according to an embodiment of the present disclosure, may include transferring the color tone information of the reference video to the plurality of videos. According to an embodiment of the present disclosure, a method of representing colors of the sample frames is not limited to YUV, and may include other color representation methods (e.g., YCbCr, LAB, and HSV)

The transferring of the color tone information of the reference video to the plurality of videos according to an embodiment of the present disclosure may include obtaining a channel-wise average and a channel-wise standard deviation of a current video from among the plurality of videos, normalizing data of each channel of the current video by using the channel-wise average and the channel-wise standard deviation of the current video and a channel-wise average and a channel-wise standard deviation of the reference video, and transferring the color tone information of the reference video to the current video by blending the data of each channel of the current video with the normalized data of each channel of the current video, based on a difference between the channel-wise average of the current video and the channel-wise average of the reference video.

The obtaining of the image quality-related parameter of the reference video according to an embodiment of the present disclosure may include obtaining a sharpness corresponding to each of the plurality of videos, determining a maximum sharpness from among the sharpness values corresponding to the plurality of videos, and determining a sharpness enhancement strength corresponding to each of the plurality of videos by comparing the maximum sharpness with the sharpness corresponding to each of the plurality of videos.

The obtaining of the plurality of videos whose image quality is adjusted according to an embodiment of the present disclosure may include enhancing the sharpness of each of the plurality of videos by using the sharpness enhancement strength corresponding to each of the plurality of videos.

The obtaining of the sharpness corresponding to each of the plurality of videos according to an embodiment of the present disclosure may include generating a low-frequency image by applying a Gaussian blur to a Y channel of a sample frame included in an input video from among the plurality of videos, detecting an edge area in the Y channel of the sample frame included in the input video by using an absolute difference between the low-frequency image and the Y channel of the sample frame included in the input video, removing noise from the edge area, and obtaining a sharpness of the input video by averaging edge scores of the edge area from which the noise is removed.

The obtaining of the plurality of videos having the same sharpness as the reference video according to an embodiment of the present disclosure may include detecting an edge area of each frame included in a current video by applying a Gaussian blur to a Y channel of each frame included in the current video from among the plurality of videos, removing noise from the edge area, and applying a sharpness enhancement strength corresponding to the current video to the edge area from which the noise is removed.

The electronic device 1000, according to an embodiment of the present disclosure, may include the memory 1700 in which a program or at least one instruction is stored, and at least one processor 1300. The electronic device 1000 may receive a user input that selects a plurality of videos to be edited into one video. The electronic device 1000 may determine a reference video from among the selected plurality of videos. The electronic device 1000 may obtain an image quality-related parameter of the reference video by analyzing the reference video. The electronic device 1000 may obtain a plurality of videos whose image quality is adjusted, by applying the image quality-related parameter of the reference video to each of the plurality of videos. The electronic device 1000 may perform editing by combining the plurality of videos whose image quality is adjusted into one video.

A machine-readable storage medium may be provided as a non-transitory storage medium. As used herein, the term non-transitory refers to a storage medium that does not include a signal (e.g., an electromagnetic wave) and is tangible, but does not distinguish whether data is stored semi-permanently or temporarily in the storage medium. For example, a non-transitory storage medium may include a buffer in which data is temporarily stored.

According to an embodiment of the present disclosure, methods according to various embodiments of the present disclosure may be provided in a computer program product. The computer program product may be a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as memory of a server of a manufacturer, a server of an application store, or a relay server.

While this invention has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. A method of editing a video by an electronic device, the method comprising:
receiving a first user input indicating a selected plurality of videos to be edited into a single output video;
determining a reference video from among the selected plurality of videos;
obtaining a reference image quality-related parameter of the reference video by analyzing the reference video;
applying the reference image quality-related parameter to each video of the selected plurality of videos resulting in a plurality of adjusted videos whose image quality has been adjusted; and
combining the plurality of adjusted videos into the single output video.

2. The method of claim 1, wherein the reference image quality-related parameter comprises at least one of a contrast score, color tone information, or a sharpness enhancement strength.

3. The method of claim 1, further comprising:
adjusting, based on receiving a second user input, a combination order of the plurality of adjusted videos.

4. The method of claim 1, wherein the determining of the reference video comprises:
determining, as the reference video, a first video from among the selected plurality of videos, based on a combination order of the selected plurality of videos.

5. The method of claim 1, wherein the determining of the reference video comprises:
determining, as the reference video, a video selected by a user from among the selected plurality of videos.

6. The method of claim 1, further comprising:
providing, to a user, a list of the plurality of adjusted videos;
receiving a third user input selecting a first video from among the plurality of adjusted videos;
providing, to the user based on receiving the third user input, a first image quality-related parameter of the first video;
receiving a fourth user input adjusting the first image quality-related parameter of the first video; and
additionally adjusting the first image quality-related parameter of the first video, based on receiving the fourth user input.

7. The method of claim 1, wherein the obtaining of the reference image quality-related parameter comprises:
converting each video of the selected plurality of videos into a YUV format; and
analyzing the reference video converted into the YUV format, and
wherein the obtaining of the plurality of adjusted videos comprises:
applying the reference image quality-related parameter to the selected plurality of videos converted into the YUV format; and
converting each adjusted video of the plurality of adjusted videos into an RGB format.

8. The method of claim 1, wherein the obtaining of the reference image quality-related parameter comprises:
selecting sample frames from among a plurality of frames comprised by the reference video; and
obtaining the reference image quality-related parameter of the reference video by analyzing the selected sample frames.

9. The method of claim 8, wherein the obtaining of the reference image quality-related parameter comprises:
determining a reference contrast score of the reference video by using an intensity value of a Y channel of the selected sample frames comprised in the reference video, and
wherein the obtaining of the plurality of adjusted videos comprises:
applying the reference contrast score to the selected plurality of videos.

10. The method of claim 9, wherein the applying of the reference contrast score comprises:
determining a current contrast score of a current video from among the selected plurality of videos; and
based on the current contrast score being higher than the reference contrast score, reducing a contrast of the current video by blending each frame comprised in the current video with a gray image.

11. The method of claim 9, wherein the applying of the reference contrast score comprises:
determining a current contrast score of a current video from among the selected plurality of videos; and
based on the current contrast score being lower than the reference contrast score, dividing each frame of the current video into a plurality of patches, obtaining a mapping function corresponding to each patch of the plurality of patches, and enhancing a contrast of the current video by determining an intensity value of a corresponding pixel comprised in each frame of the current video by using mapping functions corresponding to neighboring patches of the corresponding pixel.

12. The method of claim 11, wherein the obtaining of the mapping function comprises:
obtaining a histogram corresponding to each patch of the plurality of patches;
determining a clip value of each histogram by using a mean intensity value of each patch of the plurality of patches, a variance of intensity values of each patch of the plurality of patches, and an intensity value of a center pixel;
obtaining a modified histogram by distributing bins of the histogram counted more than the clip value to other bins; and
generating, as the mapping function, a cumulative distribution function by accumulating the modified histogram.

13. The method of claim 11, wherein the enhancing of the contrast of the current video comprises:
determining the intensity value of the corresponding pixel by interpolating the mapping functions based on a spatial distance between the corresponding pixel and centers of the neighboring patches.

14. The method of claim 1, wherein the obtaining of the reference image quality-related parameter comprises:
obtaining color tone information of the reference video by using an average and a standard deviation of each of a Y channel, a U channel, and a V channel of sample frames comprised by the reference video, and
wherein the obtaining of the plurality of adjusted videos comprises:
transferring the color tone information of the reference video to the selected plurality of videos.

15. The method of claim 14, wherein the transferring of the color tone information comprises:
obtaining a current channel-wise average and a current channel-wise standard deviation of a current video from among the selected plurality of videos;
normalizing data of each channel of the current video by using the current channel-wise average, the current channel-wise standard deviation, and a reference channel-wise average and a reference channel-wise standard deviation of the reference video; and
transferring the color tone information of the reference video to the current video by blending the data of each channel of the current video with the normalized data of each channel of the current video, based on a difference between the current channel-wise average and the reference channel-wise average.

16. The method of claim 1, wherein the obtaining of the reference image quality-related parameter comprises:
obtaining a plurality of sharpness values respectively corresponding to the selected plurality of videos;
determining a maximum sharpness value from among the plurality of sharpness values; and
determining a sharpness enhancement strength corresponding to each video of the selected plurality of videos by comparing the maximum sharpness value with a sharpness value corresponding to each video of the selected plurality of videos, and
wherein the obtaining of the plurality of adjusted videos comprises:
enhancing a sharpness of each video of the selected plurality of videos by using the sharpness enhancement strength corresponding to each video of the selected plurality of videos.

17. The method of claim 16, wherein the obtaining of the plurality of sharpness values comprises:
generating a low-frequency image by applying a Gaussian blur to a Y channel of a sample frame comprised by an input video from among the selected plurality of videos;
detecting an edge area in the Y channel of the sample frame by using an absolute difference between the low-frequency image and the Y channel of the sample frame;
removing noise from the edge area; and
obtaining a sharpness value of the input video by averaging edge scores of the edge area from which the noise is removed.

18. The method of claim 16, wherein the obtaining of the plurality of adjusted videos comprises:
detecting an edge area of each frame comprised by a current video by applying a Gaussian blur to a Y channel of each frame comprised in the current video from among the selected plurality of videos;
removing noise from the edge area; and
applying a current sharpness enhancement strength corresponding to the current video to the edge area from which the noise is removed.

19. An electronic device, comprising:
memory storing at least one instruction; and
at least one processor comprising processing circuitry,
wherein the at least one instruction, when executed by the at least one processor, cause the electronic device to:
receive a user input indicating a selected plurality of videos to be edited into a single output video;
determine a reference video from among the selected plurality of videos;
obtain an image quality-related parameter of the reference video by analyzing the reference video,
apply the image quality-related parameter to each video of the selected plurality of videos resulting in a plurality of adjusted videos whose image quality has been adjusted; and
combine the plurality of adjusted videos into the single output video.

20. A non-transitory computer-readable storage medium storing a computer-executable program for editing a video that, when executed by at least one processor of an electronic device, cause the electronic device to:
receive a user input indicating a selected plurality of videos to be edited into an single output video;
determine a reference video from among the selected plurality of videos;
obtain an image quality-related parameter of the reference video by analyzing the reference video,
apply the image quality-related parameter to each video of the selected plurality of videos resulting in a plurality of adjusted videos whose image quality has been adjusted; and
combine the plurality of adjusted videos into the single output video.
